(19) United States
(12) Patent Application Publication
(10) Pub. No.: US 2025/0300540 A1
(43) Pub. Date: Sep. 25, 2025

(54) TORQUE DENSE ELECTRIC MOTOR

(71) Applicant: TOYON RESEARCH CORPORATION, Goleta, CA (US)

(72) Inventor: Eric Emile SANDOZ, Goleta, CA (US)

(21) Appl. No.: 18/861,700

(22) PCT Filed: May 3, 2023
(86) PCT No.: PCT/US2023/066565

§ 371 Date: Oct. 30, 2024

Related U.S. Application Data
(60) Provisional application No. 63/364,110, filed on May 3, 2022.

(51) Int. Cl. H02K 49/10

(52) U.S. Cl. CPC H02K 49/102

(57) ABSTRACT

This disclosure describes a magnetically geared apparatus that is configured either as an electric motor or as a generator. The apparatus includes at least a stator structure and a rotor structure arranged in a manner to improve torque generation. The stator structure contains N≥1 stator cores and a shared toroidal electrical winding, and the rotor structure contains an equal number of corresponding rotor cores. The apparatus may be a Vernier machine. The apparatus may include one or more thermal channels configured to transport heat out of the stator structure. Methods and systems for manufacturing the apparatus are also described.

### CROSS-REFERENCES TO RELATED APPLICATIONS

This application claims priority from U.S. Provisional Application No. 63/364,110 filed on May 3, 2022, the entire contents of which is hereby incorporated by reference.

### FIELD

This technology generally relates to electric motors and generators.

### BACKGROUND

Electric motors are used in a wide range of applications from powering fans and compressor pumps in heating ventilation and air conditioning (HVAC) systems, to driving the wheels of an electric vehicle (EV), to powering the propeller of a boat, electric aircraft or an unmanned aerial vehicle (UAV). There is currently an explosion of electrification from electric vehicles to small and medium sized electrically powered UAVs to new electrically powered manned aircraft for the urban air mobility (UAM) market. The explosion continues in the space of robotics and automated machines that need precise positioning. These new applications require motors that are both lightweight and compact, particularly for powering mobile platforms where weight and size are at a premium.

Electric motors produce two things, they produce torque (a twisting force) and power. Power is defined as the product of torque and shaft speed. Power can be increased by increasing torque and/or speed. Traditionally, lightweight, power-dense motors were made by operating at a very high-speed (>10,000 RPM), which is easier to be made lightweight, and then using a speed reducing gearbox to produce a shaft speed and torque which the load requires. For perspective, many modern electric vehicle motors spin at 12,000-16,000 RPM and then use an ˜8:1 speed reducing gearbox to supply torque to the wheels. Other recent motor types, such as direct-drive ironless motors achieve light weight for the required torque and power but must use very large diameters if the rotational speed is low. Loads such as propellers typically spin at slower speeds to maximize aerodynamic efficiency, which range from 150 RPM for a helicopter, up to ˜1,000 RPM for a manned electric vertical takeoff and landing (eVTOL) aircraft, and to ˜3,000 RPM for fixed wing aircraft. For robotics applications, the joint being driven rarely spins continuously and rather moves from controlled position to position and thus the peak joint speeds are usually well below 1,000 RPM, the robot usually requires a very high torque, low speed motor that is very compact.

### BRIEF DESCRIPTION OF THE DRAWINGS

FIG. 1A illustrates the stator of an electric motor topology (concentrated winding, outrunner type) that provides high power density but low torque density. FIG. 1B illustrates the stator of a motor topology (Vernier, inrunner) that provides high torque density but is heavy. FIG. 1C shows the stator of a motor topology (Vernier, toroidally wound dual airgap) according to an example embodiment of the present disclosure. The motor in FIG. 1C provides both high power and high torque density.

FIG. 2 schematically illustrates a motor architecture including dual-airgap Vernier electromagnetics with end-turn sandwich construction, flooded liquid lubricated bearings, and integrated power electronics, according to some embodiments of the present disclosure.

FIG. 3A illustrates a dual-airgap radial flux machine construction according to some embodiments of the present disclosure.

FIG. 3B illustrates a dual-airgap axial flux machine construction according to some embodiment of the present disclosure.

FIG. 4 illustrates a three-airgap (2 radial, 1 axial) flux machine construction according to some embodiments of the present disclosure.

FIG. 5A and FIG. 5B schematically illustrate motor designs which employ Vernier electromagnetics with a dual-airgap radial-flux configuration and Halbach array rotor magnetization, according to some embodiments of the present disclosure. FIG. 5A illustrates a machine of pole ratio=5:1 and FIG. 5B illustrates a pole ratio==11:1.

FIG. 6 illustrates a toroidal winding of open slot, detailing use of wide flat ribbons made of multiple parallel strands of magnet wire, according to some embodiments of the present disclosure.

FIG. 7 schematically illustrates a dual-airgap Vernier machine with Halbach rotor magnet arrays constructed as a radial flux machine, according to some embodiments of the present invention.

FIG. 8 schematically illustrates a dual-airgap Vernier machine with Halbach rotor magnet arrays constructed as an axial flux machine, according to some embodiments of the present invention.

FIG. 9 schematically illustrates a three-airgap machine, two axial-flux airgaps and one outer radial-flux airgap, according to some embodiments of the present invention. This embodiment employs heat pipes in the cooling channels to both mechanically attach the stator cores to the stator structure and for heat transport.

FIG. 10 schematically illustrates a three-airgap variant with two radial flux airgaps and one axial flux airgap, according to some example embodiments of the present disclosure.

FIG. 11 schematically illustrates an axial flux dual-airgap machine with integrated power electronics and cooling features, according to some embodiments of the present disclosure.

FIG. 12A and FIG. 12B schematically illustrate a fully assembled dual-airgap axial flux machine with axial cooling airflows driven by rotor housing integrated fan blades, according to some embodiments of the present disclosure.

FIGS. 13A-D schematically illustrate an assembly procedure for the end-turn cooling-sandwich construction of the stator, according to some embodiments of the present disclosure.

FIG. 14 illustrates a liquid cooling architecture for an axial flux design according to some embodiments of the present disclosure.

FIG. 15 illustrates an example thermal FEA simulation of a radial flux Vernier machine using heat pipes, according to some embodiments of the present disclosure.

FIG. 16A and FIG. 16B illustrate 3D electromagnetic (EM) FEA simulation of eddy currents induced in different aluminum end-turn sandwich construction approaches according to some embodiments of the present disclosure.

FIG. 17A and FIG. 17B illustrate an example of wound aluminum coil with electrically insulated surface to block eddy currents, according to some embodiments of the present disclosure.

FIG. 18A, FIG. 18B and FIG. 18C illustrate an instance of axial flux dual-airgap end-turn sandwich construction utilizing rectangular heat pipes, according to some embodiments of the present disclosure.

FIG. 19A and FIG. 19B illustrate a larger motor made by axially stacking motors, according to some embodiments of the present disclosure.

FIG. 20A-20E show aspects of a dual-airgap radial flux embodiment, according to some embodiments of the present disclosure.

FIG. 21A and FIG. 21B illustrate a rotor with a Halbach array of magnets implemented thereon according to some embodiments of the present disclosure.

FIG. 22 illustrates a split tooth Vernier stator, in the form of a radial flux outrunner, according to some embodiments of the present disclosure.

FIG. 23A and FIG. 23B show views of a five-airgap axial flux motor according to some embodiments of the present disclosure.

FIG. 24A and FIG. 24B show views of a three-airgap axial flux motor according to some embodiments of the present disclosure.

FIG. 25A and FIG. 25B show views of a two-airgap axial flux motor, according to some embodiments of the present disclosure.

FIGS. 26A-26F show an embodiment in which the core and magnets are extended continuously on the rotor.

FIG. 27A and FIG. 27B illustrate Vernier machine stators that can be manufactured in angular segments, according to some embodiments of the present disclosure.

FIG. 28A and FIG. 28B illustrate a compact winding method with coil formed from wide ribbon with specific cutouts in end-turn sandwich, according to some embodiments of the present disclosure.

FIG. 29 illustrates an automated toroidal winding machine, according to some embodiments of the present disclosure.

FIG. 30A, FIG. 30B and FIG. 30C illustrate an axial flux machine that can use windings formed with printed circuit board (PCB) processes, according to some embodiments of the present disclosure.

FIG. 31A and FIG. 31B illustrate an additive manufacturing method for axial flux motors, according to some embodiments of the present invention.

### DETAILED DESCRIPTION OF EXAMPLE NON-LIMITING EMBODIMENTS

This disclosure is directed to a motor technology that has substantially higher torque density and power density compared to the state of the art known to the inventor. Utilizing this technology, current high-performance motors can be replaced with motors that utilize only about half of the expensive permanent magnet material and high-performance electrical steels. Thus, this technology can enable cost savings. Additionally, using the disclosed technology with lower-cost electrical steels and permanent magnets can still produce a relatively high-performance motor but significantly reduce materials cost. For example, swapping high-performance Neodymium Iron Boron (NdFeB) permanent magnets for much lower-cost (and lower-strength) ferrite magnets is a mechanism for making low cost but still highly capable motors.

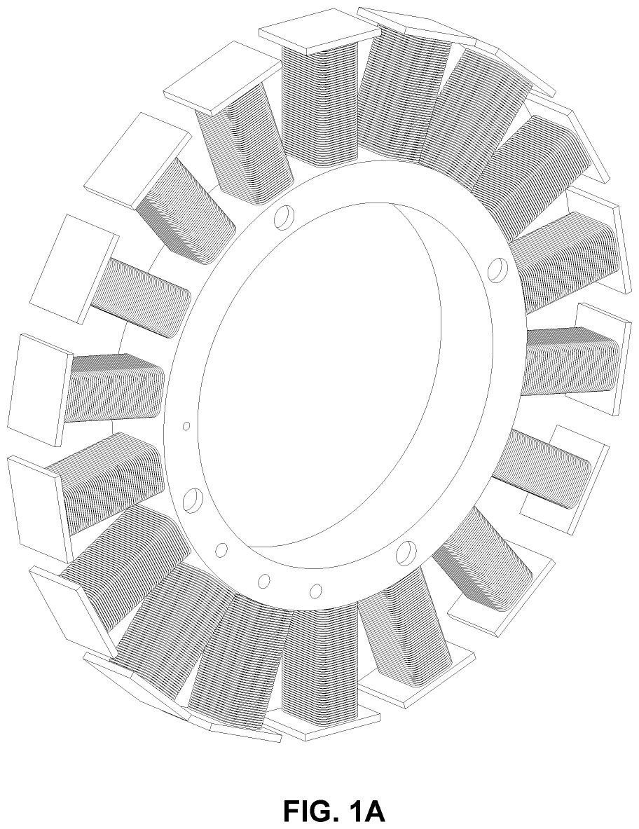

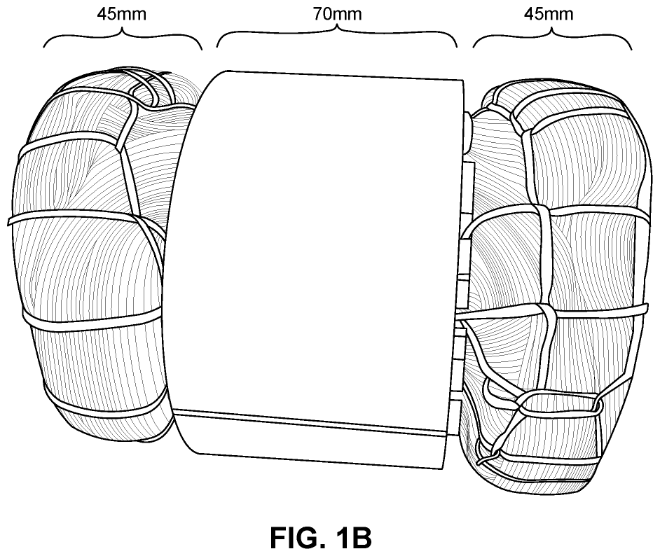

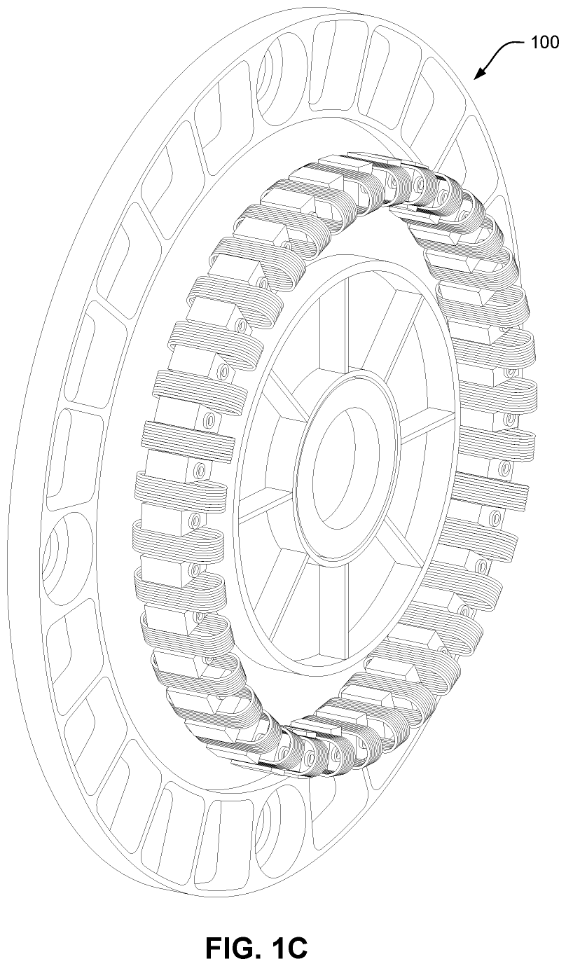

Most modern lightweight electric motors use a concentrated winding, as shown in FIG. 1A. The concentrated winding has a coil span of 1 leading to an absolute minimum of weight wasted in the end turns. However, this approach is not torque dense. FIG. 1B shows an example conventional Vernier motor which employs magnetic gearing to significantly increase torque density. The downside is that high magnetic gearing ratios (called the pole ratio) require high coil spans and thus have excessive winding weight wasted in the end turns. The example in FIG. 1B shows an excessive 90 mm of end-turn copper in the winding, compared to 70 mm of active stack length where the torque is produced.

Thus, the state of the art provides motors that are cither lightweight but have inadequate torque density (e.g., FIG. 1A) or motors that have high torque density but are too heavy (e.g., FIG. 1B). The state of the art does not, to the knowledge of the inventor, provide electric motors that are both adequately lightweight and have high torque density.

FIG. 1C illustrates the stator of a lightweight high torque density electric motor 100 using a concentrated toroidal winding, according to an embodiment of the present disclosure. The electric motor containing 100 employs magnetic gearing and comprises minimal end turns. In an example embodiment of the present disclosure, two Vernier motors are placed back-to-back in such a way that magnetic gearing of any ratio such as in the motor of FIG. 1B can be employed with a winding that has the same minimal waste of end-turn copper of the concentrated winding in the motor of FIG. 1A. This combination enables construction of electric motors that are simultaneously both highly torque-dense and power-dense.

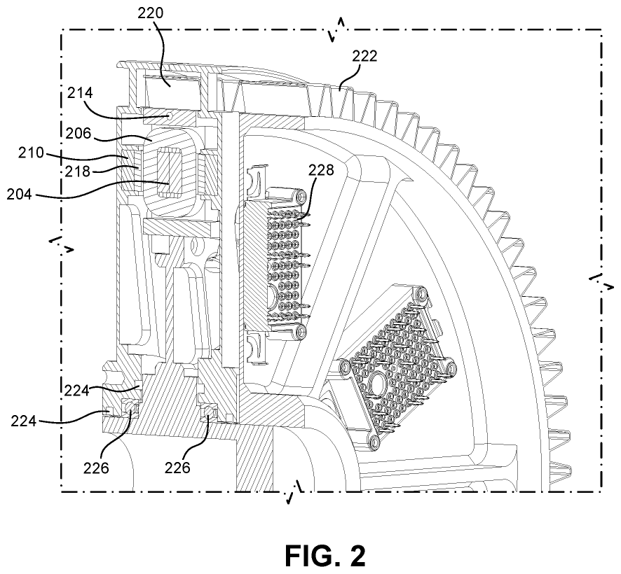

Faced with a need for an electric motor that is both lightweight and has high torque density, the inventor initially explored magnetic gearing (replacing mechanical gearing) as a zero-wear means of speed reduction. However, magnetic gears introduce the need for an additional set of bearings which can itself fail and also adds to system weight. In the context of using magnetic gearing for an electric motor, the inventor noted that the full output torque of a magnetic gear is produced by a magnetic field, permanent magnets, and electrical steel components. The magnets and iron in the magnetic gear have weight but produce no power (i.e., they are passive). Therefore, the inventor began exploring why the full output torque cannot be produced directly with a motor, leading him to the technology of example embodiments by which this (i.e., full output torque being produced directly with a motor) is achieved! An example of the technology is shown in FIG. 2.

While exploring the literature on magnetic gears the inventor came across a class of machines called Magnetically Geared Machines (MGMs) and among them is the Vernier machine which employs magnetic gearing with its rotor magnets, pole/slot combinatorics and open slot construction. Vernier motors were developed primarily for very high torque, very low speed applications like wind turbine generators. Since efficient propellers spin much more slowly than lightweight electric motors generally, the Vernier machine represented a good candidate for applications such as direct-drive aircraft propulsion applications being explored by the inventor. The challenge was to make it lightweight.

In proceeding to construct a lightweight highly torque dense motor according to this disclosure, as one of the first steps in achieving lower weight at low mechanical speeds, a high pole count (i.e., large number of magnet poles, for example, greater than 4), which increases the electrical speed of the machine, was used. Next, Halbach magnetization was employed on the rotor to minimize the weight of the iron in the rotor core. High electrical speeds generally produce higher core losses, therefore very low loss electrical steels were used in the cores of example embodiments. Additionally, the magnets were segmented to minimize eddy currents in the magnets.

FIG. 1B shows a typical Vernier motor, which because of the magnetic gearing leads to large coil spans, which leads to excessive copper in the end-turns. One of the key insights that enabled the technology of the embodiments of this disclosure is the realization that a Halbach “inrunner” Vernier motor and an “outrunner” Vernier motor can be arranged back-to-back to form a dual-airgap machine with the stators clocked such that a short toroidal winding can be used. This approach practically eliminates the excess winding at end-turns and produces a very compact machine. It was found that cooling channels can be run through the center of the stator and rotor yokes without degrading the magnetic performance of the machine. All of this were combined with a thermally conductive cooling sandwich around the winding end-turns (usually the hottest part of the motor) to produce very effective cooling. This mechanical/thermal design approach of embodiments is referred to in this disclosure as “cold sandwich” construction.

Dual-airgap has been used for ironless and conventional slotted motors (e.g., U.S. Pat. No. 6,924,574) and has been proposed in Niu et al, “Quantitative Comparison of Novel Vernier Permanent Magnet Machines,” IEEE Transactions on Magnetics, vol. 46, no. 6, pp. 2032-2035, 2010. However, these known techniques do not consider a Vernier machine, as provided in embodiments of the present disclosure. Additionally, some embodiments utilize a combination of Halbach magnetization along with particular cooling methods. Moreover, the technology of embodiments is equally applicable to radial-flux and axial-flux machines as well as combinations of them. Furthermore, the technology is equally well suited to embodiments of generators, linear motors and actuators.

The potential applications for the motor of example embodiments include but are not limited to those for which weight and volume are significant concerns. At the top of this list are electric aircraft propulsion motors for either fixed-wing horizontal flight and vertical flight such as helicopters and multi-copters. Another class of applications are those that seek to reduce or eliminate speed-reducing gearboxes. Common motivations for this are eliminating wear and maintenance items, and reducing system volume and weight. Mobile power generation from truck-towed generators to even stationary backup generators can have a significant size and weight savings with the technology of the embodiments, enabling easier transport and installation of these devices. Similarly, electric generators in aircraft increasingly need to produce more electric power as demand for greater electric loads is seen across all applications. Airborne electric power generation highly prize lightweight, compact and efficient generators. Evolving technologies like robotics have another reason for removing gearboxes which is to enable back-drivable actuators which can be more rugged and enable new kinds of control algorithms and robot performance. Electric motors that drive fans and pumps that can benefit from a more compact and lightweight motor are other potential applications.

Since the motor technology of example embodiments of this disclosure has significantly higher torque density and power density compared to the state of the art, the technology can also replace current high-performance motors with one that utilizes significantly less of the expensive permanent magnet and high-performance electrical steels. Thus, this technology can enable cost savings. Similarly, using this technology with lower-cost electrical steels and permanent magnets can still produce a relatively high-performance motor but significantly reduce materials cost. Swapping high-performance Neodymium Iron Boron (NdFeB) permanent magnets for lower-cost (and lower-strength) ferrite magnets, for example, is an option for making low cost but still highly capable motors.

Embodiments provide a new electric motor technology that produces very high torque at lower desired speeds, while still being highly efficient and very compact. In embodiments, this is achieved by combining multiple technologies in a unique manner. In some embodiments, the multiple technologies include Vernier electromagnetics, high pole count, Halbach array rotor magnets, two or more back-to-back motor stators with appropriate clocking, cooling channels sandwiched between the two or more stator yokes, cooling fins integrated into rotor structure, highly thermally conductive stator winding end caps, winding made from ribbon composed of many smaller wire strands, integrated heatsink fins on the motor housing, drive electronics integrated in the same motor housing, and cooling channels integrated into rotor cores. In some embodiments, one or more of the integrated heatsink fins on the motor housing, the drive electronics integrated in the same motor housing, and the cooling channels integrated into rotor cores may be optional to be included in the motor.

Vernier electromagnetics is a type of magnetically geared machine (MGM). The Vernier MGM produces very high torque, but typically has very large end-turn size and mass (e.g., FIG. 1B). In example embodiments, the Vernier MGM works for both radial and axial flux machines as well as linear motors, and it can also be used on induction, interior permanent magnet (IPM), synchronous reluctance machines (SRMs), and synchronous Machines (SMs).

The high pole-count technology incorporated into a motor in this disclosure may have 4 or more permanent magnet poles. The high pole count provides for increasing the electrical speed of the machine while keeping the mechanical speed low.

Halbach array rotor magnets can be used in some embodiments to maximize the flux density toward the stator and enables a thinner rotor yoke to carry the flux. Some embodiments may use magnet arrangements that are not Halbach arrays.

The two back-to-back motor stators with the clocking as arranged in example embodiments allow for a very compact winding with a minimum (e.g., absolute minimum) of copper wasted in the end-turns, and places the rotors on the outside of the machine, which enables very effective cooling of the rotors to keep magnet temperatures lower.

The cooling channels sandwiched between the two stator yokes enable a very short path for heat to flow out of the stator via the cooling channels. The cooling channels can be filled with a thermally conductive solid (called a cooling bar), a heat pipe or liquid coolants. Cooling channels can be cavities in the stator and rotor laminations. Cooling channels can also be formed in an aluminum plate—for example, with the two stator cores mounted/bonded to the cooling plate. Effective cooling keeps winding temperatures lower, which improves efficiency as well as increases service life of the winding.

Cooling fins integrated into the rotor structure in example embodiments enable, since the rotor structure is exposed to air, directly cooling the rotor core and magnets. This results in improved performance since motor performance is limited by magnet temperature. The cooling fins integrated into rotor structure also enables use of higher-strength magnets which require lower operating temperatures.

Highly thermally conductive stator winding end caps in embodiments are arranged to contact the winding end-turns providing a low resistance path for winding end-turn heat to flow to the cooling channels and the housing, and can be specially constructed to not produce, or minimize, eddy currents which may reduce efficiency.

Windings made from ribbon composed of many smaller wire strands also contributes several attributes in some embodiments. Fine stranding reduces winding AC resistance and reduces eddy currents from being induced in the strands themselves in the open slots. Square/rectangular cross-section wire can be used to form the ribbons, this enables a very high packing factor which improves efficiency.

Integrated heatsink fins on the motor housing, in some embodiments, provide a very compact cooling solution.

Drive electronics integrated in the same motor housing, in some embodiments, use the same cooling fins for a very compact system. It can also make motor installation and system design simpler because it eliminates the requirement to find a place to mount the motor drive electronics.

Cooling channels may be integrated in rotor cores in some embodiments. Such channels help cool rotor magnets and can form an integral centrifugal coolant pump. They can also provide mounting features.

The above components, in various combinations, describe features that enable a highly torque dense electric motor as provided in embodiments of this disclosure. Some of these features, which are unique to this motor technology, may additionally require new manufacturing processes and systems to produce the motor. These manufacturing processes and systems include, for example, a toroidal winding machine with precise control of wire entry into slot; an integrated cutting and spooling method for fabricating axial flux machines with interior and exterior cutouts; laminated aluminum end cap rings with winding cutouts; and bonding square/rectangular magnet wires into ribbon along with careful folding to compactly route wire ribbons; segmented stator assembly; and modular stackability of axial flux motors to form a bigger motor.

Electromagnetic Aspects of the Torque Dense Electric Motor

The following are some electromagnetic aspects of the technology that, in select combinations used in example embodiments, result in high performance, high torque-density and high power-density motors/generators.

FIG. 2 shows a cross-section of a dual-airgap radial flux machine such as the embodiment of FIG. 1C. and illustrates an example arrangement of stator cores 204, a winding 206, a rotor core 210, magnets 218, and a cooling channel 214. FIG. 2 also shows shaft seals 224 and flooded bearings 226, integrated electronics 228 and heat sinks 220-222. These aspects are described further with respect to various embodiments below.

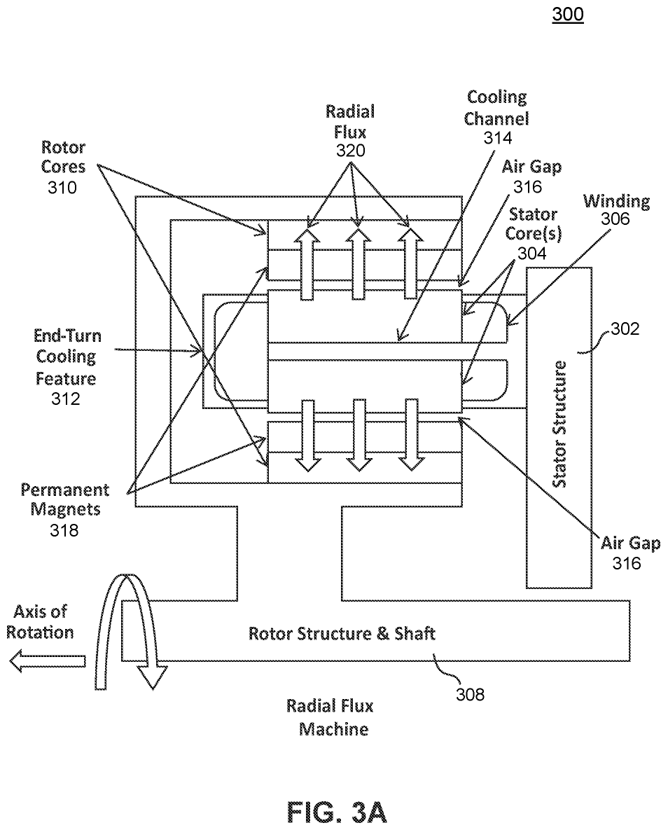

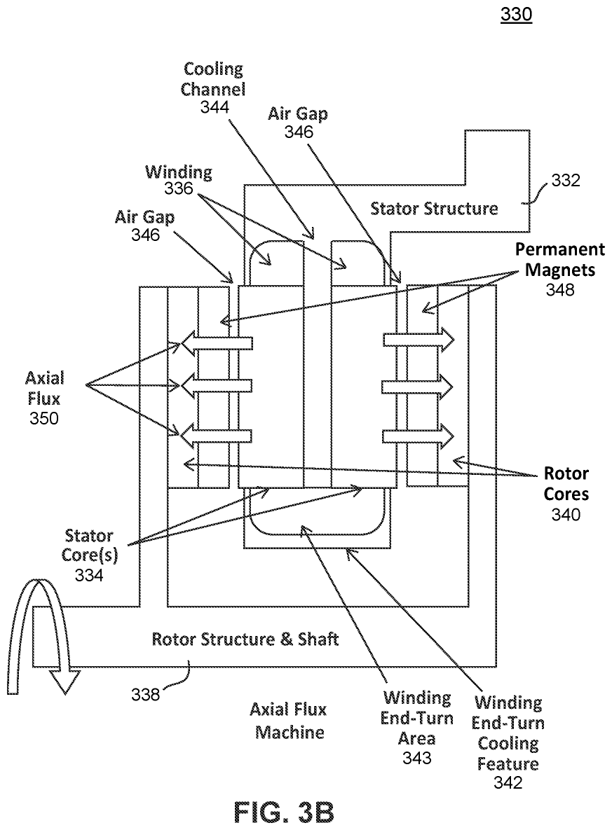

FIG. 3A and FIG. 3B show two primary configurations in which the motor technology according to embodiments can be constructed for either a radial-flux machine (FIG. 3A) or an axial-flux machine (FIG. 3B). FIGS. 3A-3B each shows a cross-section view of only the upper half of a motor according to some embodiments, similar to what is shown in FIG. 2. The radial-flux machine 300 in FIG. 3A comprises a stator core 304 connected to a stator structure 302, permanent magnets 318, and rotor cores 310 connected to a rotor structure 308 such that a flux 320 is generated in the radial direction. The axial-flux machine 330 in FIG. 3B comprises a stator core 334 connected to a stator structure 332, permanent magnets 348, and rotor cores 340 connected to a rotor structure 338 such that a flux 350 is generated in the axial direction. The radial machine and axial machine of embodiments each includes two airgaps. An airgap, in example embodiments, is a mechanical gap between the rotor permanent magnets and the stator core. Each of FIGS. 3A and 3B shows key components that make up the subject technology. Key features include the multiple airgaps (316 in FIG. 3A and 346 in FIG. 3B), the winding (which is toroidally wound; 306 in FIG. 3A and 336 in FIG. 3B), the cooling channel (314 in FIG. 3A and 344 in FIG. 3B) embedded in the stator core, as well as an end-turn cooling feature (312 in FIG. 3A and 343 in FIG. 3B). In addition, the stator (304 in FIG. 3A and 344 in FIG. 3B) and its cooling features are connected to the stator structure (302 in FIG. 3A and 332 in FIG. 3B). A characteristic of the subject technology is the very short thermal path from the cooling features (end-turn area and channel), which transports heat generated in the winding and stator cores to the stator structure and out to a heatsink. While there are multiple ways to mechanically arrange the rotor and stator structures for each of the radial and axial flux variants, two examples are shown in FIGS. 3A-3B.

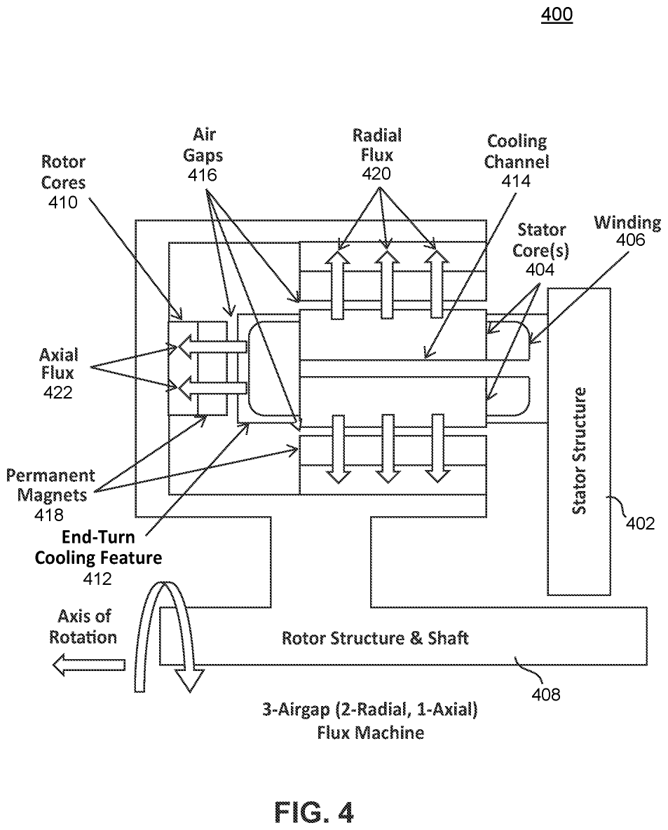

FIG. 4 shows how an axial-flux rotor core and magnets can be added to the radial-flux construction to construct a three-airgap machine 400, according to some embodiments. As illustrated the stator structure 402, stator cores 404, winding 406, rotor structure 408, rotor cores, permanent magnets, cooling channel 414 and an end-turn cooling feature 412 are constructed in a manner similar to that of the radial-flux machine 300. For the three-airgap machine 400, extra stator core material (with a radial lamination direction) may be added as well. With the added axial-flow rotor core(s) and permanent magnet(s), the machine 400 comprises three airgaps 416, three rotor cores 410, and three permanent magnet 418. The machine provides a radial flux 420 as well as an axial flux 422.

In a similar manner to machine 400, in another embodiment, a radial-flux section can be added to the axial-flux motor (to either the inner diameter or the outer diameter) to form a different type of three-airgap machine.

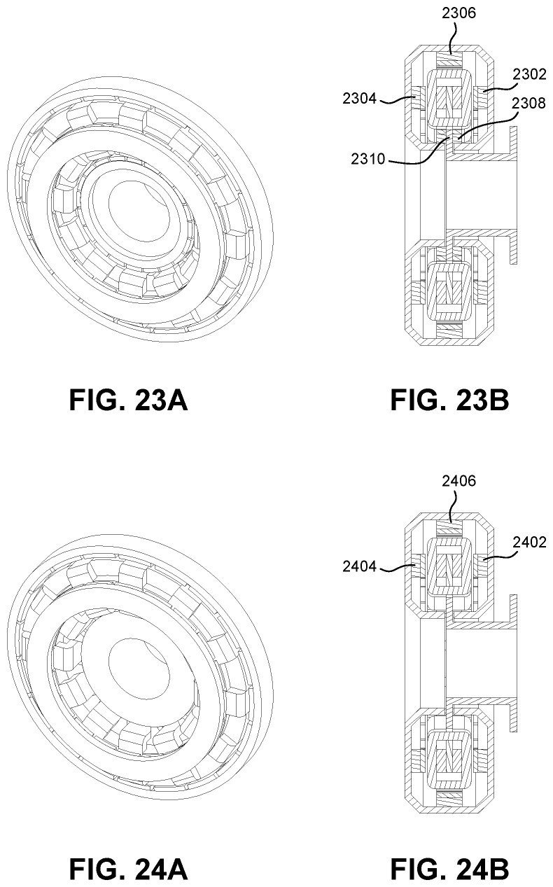

In another embodiment, another axial flux rotor can be added (e.g., to the right side of the arrangement shown in FIG. 4) to form a four or five airgap machine. However, this additional axial flux rotor has to be split in half to enable the stator to connect to the stator structure. An example five-airgap configuration is shown in FIG. 23A-B. Configurations of progressively higher number of airgaps can be constructed in a similar manner. Let N be the number of airgaps, then N=3 is a three-airgap machine, and N=4 and N=5 are four and five airgap machines respectively. In the limit N can be thought to go to infinity and the components of the different airgaps merge into one continuum.

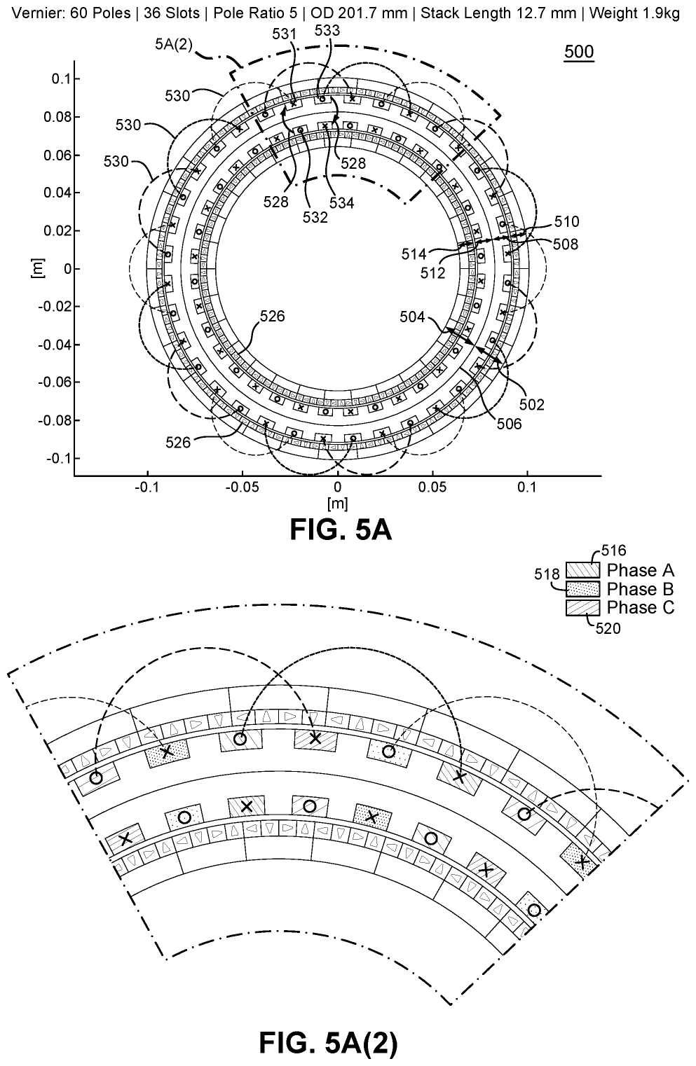

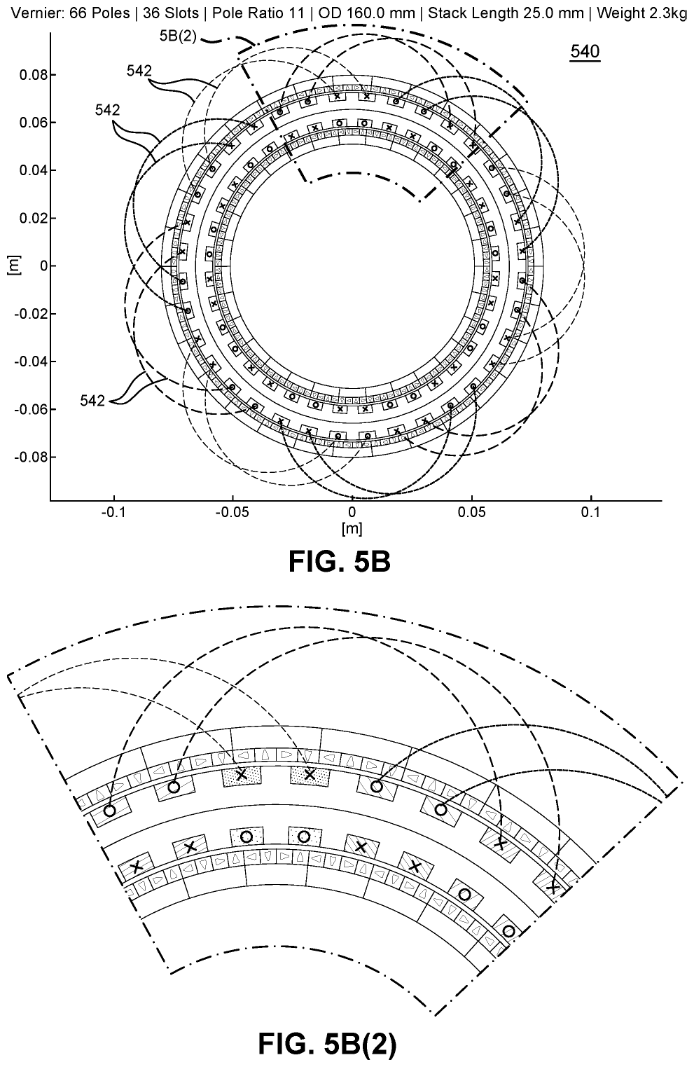

FIG. 5A schematically illustrates certain electromagnetic aspects of a motor in accordance with an embodiment, for an example, a 60 pole 36 slot motor which has a magnetic gearing pole ratio of 5:1. A critical aspect of the motor is that the system is effectively composed of two motors 502 and 504 placed back-to-back. The circular boundary 506 delineates the boundary between the two motors. There is an “outrunner” type motor 502 on the outside of circle 506 (so called an outrunner because the rotor 510 is on the outside of the stator 508). Then there is an “inrunner” motor 504 on the inside of circle 506 where the inner rotor 514 is on the inside of the inner stator 512. An arrangement of Halbach magnets 526 is shown in each motor. The example shown is a Vernier machine, which is defined as a motor with magnetic gearing and thus a pole ratio >1.

The slot fill patterns indicate the phases of the respective windings, with shading 516 being Phase A, shading 518 being Phase B, and shading 520 being Phase C. For each phase there is a more densely patterned slot (e.g., slot 531, 534) marked with an “x” indicating the winding entering the page which must be connected to another slot (e.g., slot 532, 533) of a more sparsely patterned slot marked with a “o”, indicating where the winding must exit the page. The outer connection semi-circles (e.g., 530 shown in dashed lines) show how a conventional winding would look if this motor were conventionally wound. For the example shown, the pole ratio is 5 and the coil span is 3 slots. However, in the illustrated embodiment the two stators 508 and 512 are oriented such that the in and out directions of the same phase of each winding are clocked such that the option of winding it with a toroidal winding (and thus with minimal excess end-turn winding) is available. Two examples of toroidal winding 528 are shown, as an example. One of the illustrated toroidal windings 528 goes from a phase B 518 inner stator slot 532 to a same phase outer stator slot 531, while the other of the illustrated toroidal windings 528 goes from a phase C 520 outer stator slot 533 to a same phase inner stator slot 534. It is this radial clocking of the two stators 508 and 512 that primarily enables the very short end-turn windings independent of how big the coil span is. Thus, this enables the use of higher pole ratios (for higher magnetic gearing) without any corresponding increase in winding end-turn weight which would happen with conventional windings. An example of what conventional winding would have looked like if it were used is shown in the dashed lines 530 between respective pairs of slots for each of the three phases. It should be understood that example embodiments would not have physical windings such as the windings 530, and would instead have the toroidal windings 528 between each pair of corresponding clocked slots in the motor 500.

FIG. 5B shows another example of a similar motor design 540 that also has 36 slots, but the arrangement shown in FIG. 5B has 66 poles which results in a Vernier machine with a pole ratio of 11:1. This higher pole ratio requires a higher coil span of 6 slots which would result in a much larger end-turn mass if a conventional winding was used. The larger coil span 542 is shown in example conventional windings in dashed lines. But in the example embodiment represented in FIG. 5B, the two stators (similar to motor 500) are clocked such that they can be wound with a short toroidal winding, greatly saving weight associated with windings. As can be observed by comparing FIGS. 5A and 5B, the length of the toroidal windings between the back-to-back stators in the two embodiments are the same, although it would have been significantly different if conventional winding were used. With regard to motor 540 too, as with motor 500, it should be understood that example embodiments would not have physical windings such as the windings 542, and would instead have the toroidal windings (similar to 528) between each pair of corresponding clocked slots in the motor 540. Clocking angles shown in FIGS. 5A and 5B show the clocking angle which results in the lowest winding mass. It should be understood that the clocking angle between the two motors may be adjusted from this angle to address other design issues such as ripple torque or power factor, however the winding mass will increase.

Open slot geometry, used with Vernier machines, enables the toroidal winding as used in example embodiments with very high fill factors (where fill factor is defined as the proportion of cross-sectional area of the slot that is copper). High fill factors are desired when making high efficiency motors and making lightweight motors. Toroidal winding enables the use of solid (i.e., not segmented) stator cores which reduces assembly cost and has superior magnetic performance to segmented cores.

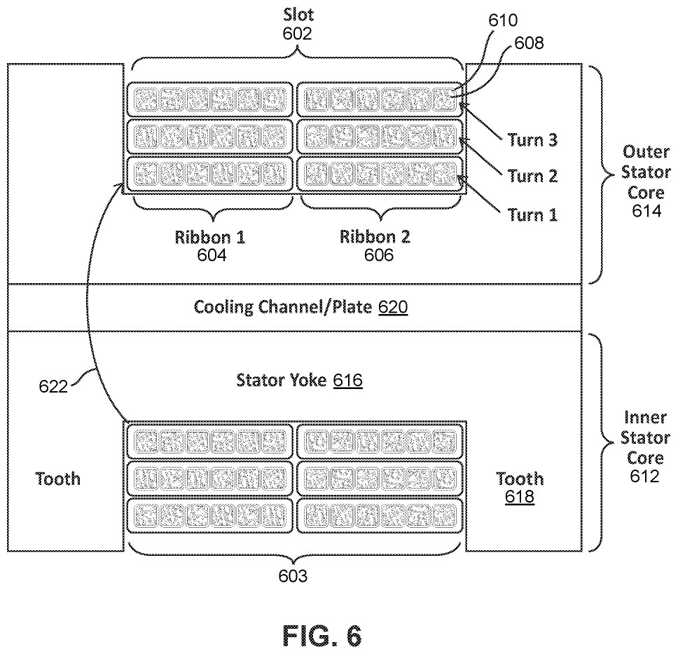

FIG. 6 details how the toroidal winding of open slots (e.g., 602, 603) can achieve very high fill factors utilizing flat ribbons (e.g., ribbons 604 and 606) of conductors. This example shows how a ribbon is formed from 6 square-cross-section magnet wires (e.g., 608). Each 608 copper wire may be surrounded by insulation 610. The wire strands can be bonded together to form a flat ribbon that is 1 conductor-width tall and 6 conductor-widths wide for example. This ribbon can be wound toroidally showing how the winding starts at the bottom of the slot, then wraps over itself to form a 3-turn coil in this case. For example, the ribbons 604 and 606 are shown to wrap 3 turns toroidally between slot 602 in outer stator 614 and slot 603 (shown to be formed between two teeth 618 in the stator yoke 616 of the inner stator 612) in inner stator 612. Two ribbons 604 and 606 are shown to illustrate that slot 602 could be filled by winding multiple ribbons and then either connecting them in series or parallel. Alternatively, a single ribbon can fill the slot width. Thus, embodiments are not limited to any particular number of ribbons. Although square cross-section magnet wire is shown, embodiments are not limited to such square cross-section wires and may use rectangular and circular shaped cross-section wire. The example in FIG. 6 shows the outer stator 614 and the inner stator 612 separated by a cooling channel/plate 620 that could, for example, be made of aluminum, and carry cooling channels within it. In some embodiments, the two stators 612 and 614 can also be made of a single piece of electrical steel with cooling/mounting channels formed within it. The arrow 622 shows the direction of the winding.

The open slot geometry used in many Vernier machines enables the flat ribbon based toroidal winding described in relation to FIG. 6, which produces a very high fill factor. The conductors in the open slot will be exposed to fringing flux from the permanent magnets. If the conductors are too large, significant eddy currents can be induced which will produce a braking torque that will erode the efficiency of the machine. For this reason, it is advantageous to make the ribbons out of many small strands to limit the eddy currents produced.

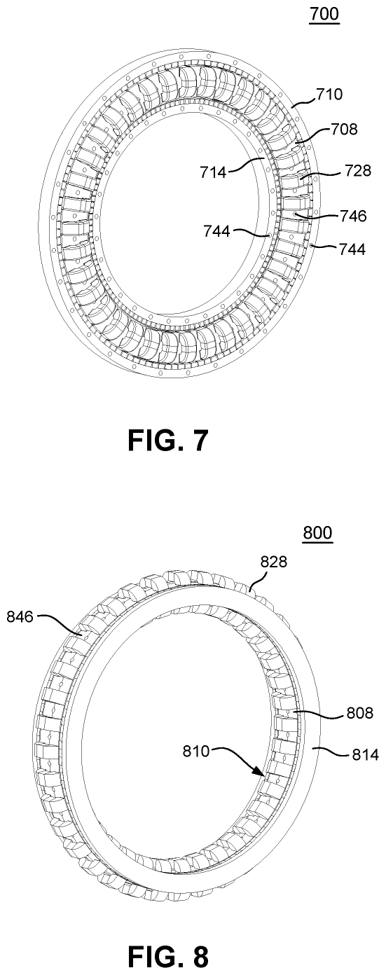

FIG. 7 shows a 3D model representation of a radial flux motor that corresponds to the embodiments shown in FIG. 5B and FIG. 6. This figure also shows the circular cooling channels in both the rotor and stator yokes. For example, cooling channels such as, for example, cooling channel 746 are provided in the stator 708, and cooling channels such as, for example, cooling channels 744 may be formed on the outer rotor 710 and the inner rotor 714. These cooling channels can be used to serve both a thermal and mechanical function. For example, they can transport heat out of the cores and can also be used as mechanical mounting features. Toroidal windings 728 between correspondingly located open slots on the stator 708 (or an inner stator and an outer stator placed back-to-back) of the radial-flux motor are also shown in FIG. 7.

FIG. 8 shows an axial-flux variant of the motor embodiment shown in FIG. 7. In FIG. 8, inner rotor 810 and outer rotor 814 may not have cooling channels therein, and the stator 808 may be configured with a plurality of cooling channels 846. It can be observed that the cooling channels 846 and toroidal windings 828 are oriented differently than in the motor embodiment shown in FIG. 7.

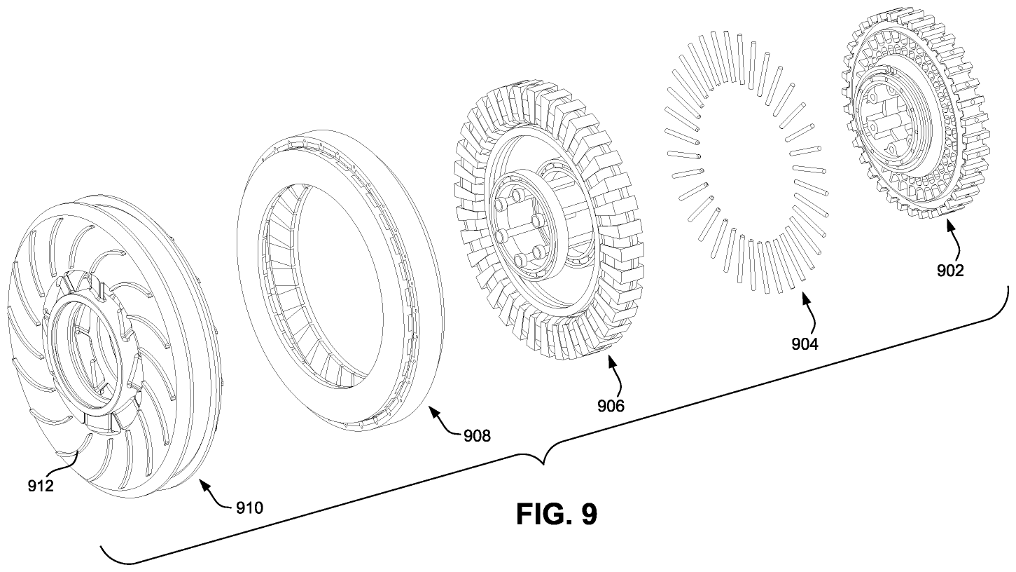

FIGS. 9-11 show some different ways in which the Vernier electromagnetics can be mechanically arranged along with different cooling solutions according to some embodiments.

FIG. 9 shows how a dual-airgap axial flux machine can be combined with an outer radial flux machine to form a three-airgap machine. The example shown uses heat pipes 904 embedded in stator core 906 (the winding is illustrated in the stator core) cooling bars (also referred to as heat pipes) that serve a dual purpose of transporting heat out of the core to the stator structure 902 (shown including cooling fins) and as structural elements for mechanically attaching the stator cores 906 to the stator structure 902. The rotor housing 910, made of a lightweight and thermally conductive material such as, but not limited to, aluminum, has integrated cooling fins 912. In the illustrated embodiment these fins are shaped to form a centrifugal fan which drives cooling air over the rotor structure to cool the rotor cores as well as the magnets. Additional fan blades that double as rotor spokes are also integrated into the rotor core. These blades form an axial fan that blows air across the stator structure to cool the stator. Integrated rotor structure and cooling fins (aluminum) 910, three-sided magnet and rotor core 908, stator core and winding 906, cooling bars 904 and stator structure and cooling fins (aluminum) 902, are shown.

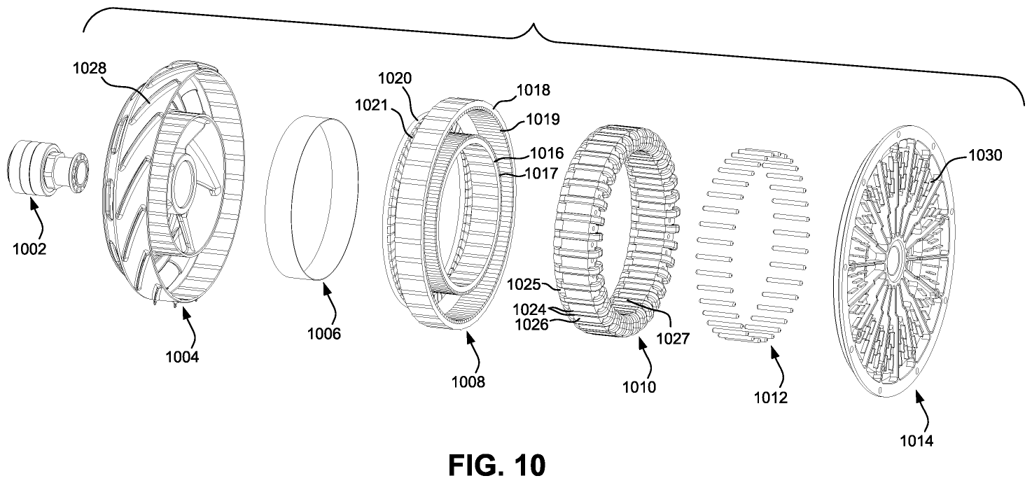

FIG. 10 shows a similar approach where a dual-airgap radial flux machine is augmented with a single axial flux component to form a three-airgap machine. The three-airgap machine comprises three rotor cores 1016, 1018, and 1020, and three rotor magnet arrays 1017, 1019, and 1021 as shown. The lamination directions for the radial flux and axial flux machines are different to prevent eddy currents in each region of the stator core. For example, rotor cores 1016, 1018 and magnet arrays 1017, 1019, being parts of the radial flux machine, have an axial lamination direction, and rotor core 1020 and magnet array 1021, being parts of the axial flux machine, have a radial lamination direction. The stator core 1024 is a part of the radial flux machine and the additional stator core 1025 is part of the axial flux machine. The illustrated stator core structure 1010 includes the stator cores 1024, 1025, 1027 and the toroidal winding 1026 between slots in the axial direction in the stator cores. Stator cooling bars 1012, which can be cither solid material, hollow coolant pipes or heat pipes, are incorporated in the stator cores. The rotor has cooling fan blades 1028 integrated into the rotor housing 1004 as well, but in this case they are all axial flow fan blades. The stator housing/structure 1014 serves to mechanically mount the stator cores 1010 (stator cores 1024 and 1025) and winding 1026, and has a plurality of cooling fins 1030 integrated into it to facilitate dissipating the stator heat conducted to it via the cooling bars 1012 and direct conductive paths from the mounting features. A shaft bearing assembly 1002 for the rotor housing 1004, and a magnet retention band 1006 are also shown. As illustrated, the winding 1026 is toroidal.

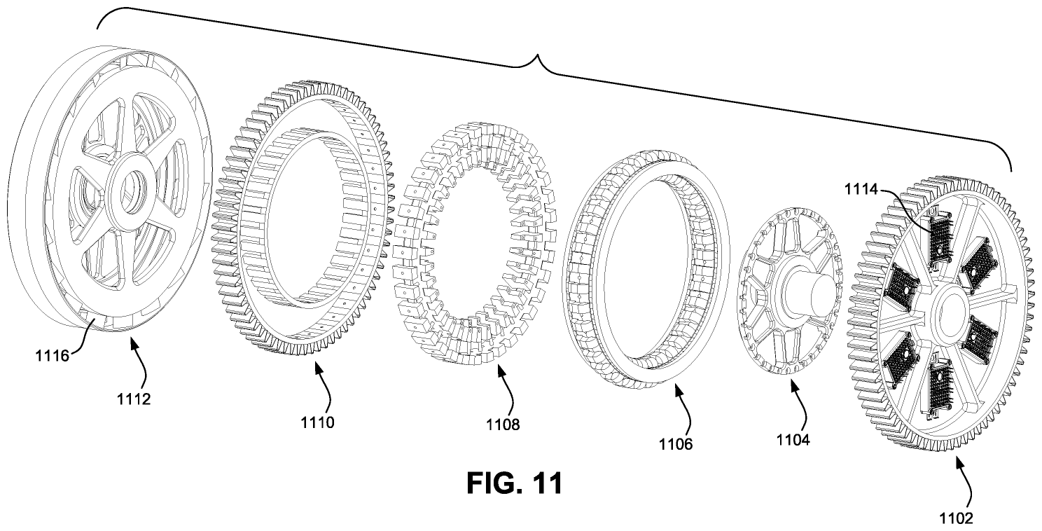

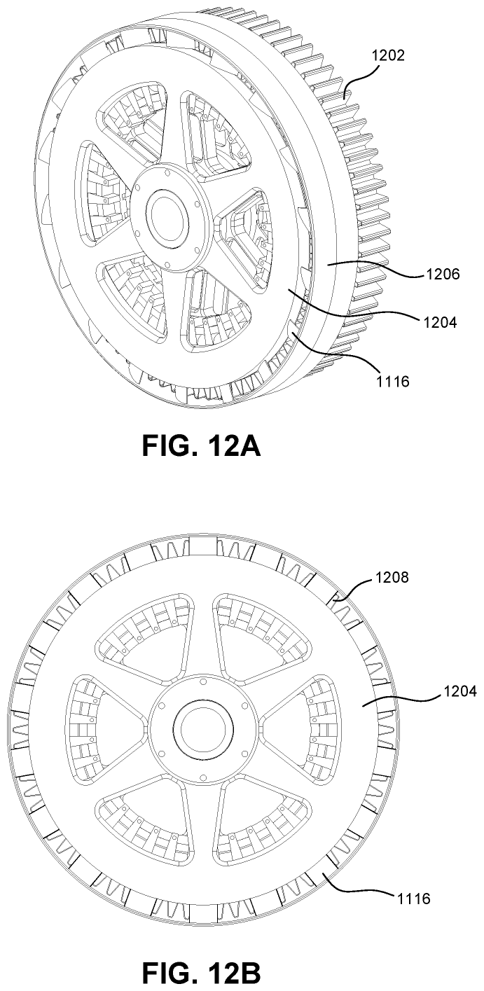

FIG. 11 shows an exploded view of a dual-airgap axial flux machine according to some embodiments. The illustrated axial flux dual airgap machine includes integrated power electronics and cooling features. This shows a stator “cold sandwich” component 1108 which is an integrated part that features the cooling bars/channels as well as features in the end-turns region to efficiently conduct heat out of the end-turns and stator core and out to the stator heat sinks 1110. This example shows a corrugated stator fin heat sink highly integrated into the outer stator structure to cool the motor. This instance also features section 1102 that comprises integrated drive electronics 1114 (e.g., power semiconductors, processor, and sensors) and its own corrugated heat sink (shown on the outer perimeter of the structure) to dissipate the heat generated in the drive electronics. This instance of the technology shows a rotor housing 1112 that envelops the stator and has integrated axial fan blades 1116, much like the compressor blades of a turbine engine. These fan blades 1016 blow air over the heat sinks (e.g., stator heat sinks 1110) as the motor spins. The stator core is formed of the stator electromagnetic components (including the toroidal windings) 1106, stator cold sandwich 1108 and stator heat sink 1110. The stator frame (including bearing seats) 1104 is also shown. Cross-sectional detail of this design is shown in FIG. 2 and a more complete portion of the motor is shown in FIG. 12A.

FIG. 12A and FIG. 12B show the un-exploded view of the motor shown in FIG. 11. FIG. 12A shows the rotor housing 1204 and 1206 (rotor housing 1112 in FIG. 11) with the incorporated axial fan blades 1116. The end-on view in FIG. 12B shows more clearly how the technology can integrate axial fan blades into the rotor housing to drive air over the corrugated heat sink fins 1208 (shown in component 1110 in FIG. 11). FIG. 12A also shows electronics heat sink 1202 (shown in component 1102 in FIG. 11).

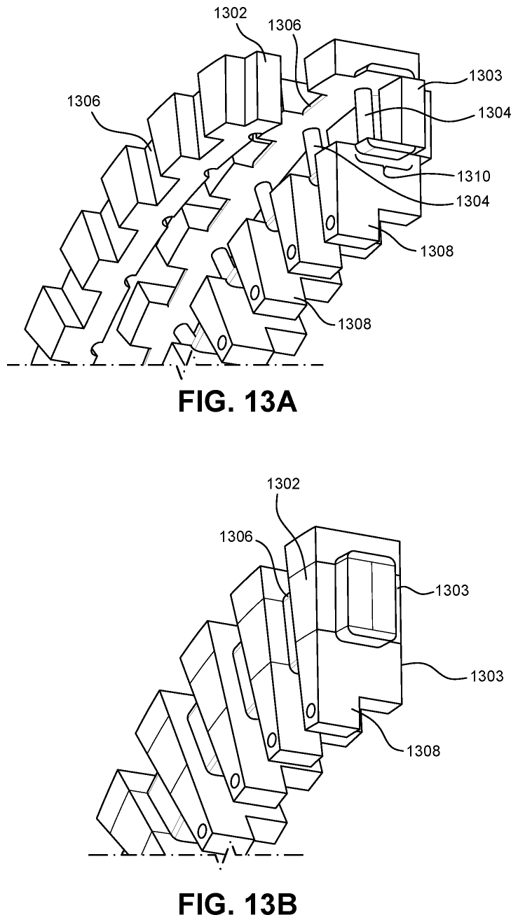

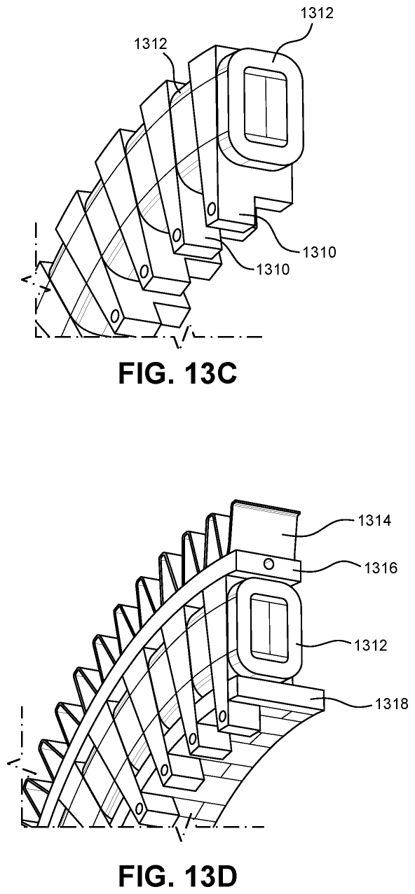

The torque-dense electric motor technology of embodiments of this disclosure makes use of an end-turn sandwich construction, the assembly of which is detailed in FIG. 13A-13D for an axial flux machine. In this case the stator is formed by two stator core halves 1302, 1303 (see FIG. 13A) each made of high-performance electrical steel, bonded to highly thermally conductive sandwich pieces composed of 1304, 1306, 1308 and 1310. The sandwich pieces contain the cooling channels 1304 and are made of highly thermally conductive materials (aluminum for example) for the winding end-turns in respective slots 1306 and 1310. The stator that is ready for winding is shown in FIG. 13B. The two stator core halves 1302 and 1303, sandwich pieces 1308 are shown in FIG. 13B after the bonding of the two stator core halves. The stator is then wound with toroidal coils 1312 in these slots 1306 between sandwich end-turns (e.g., end-turns 1310). FIG. 13C shows the wound stator. Lastly the outer coolant manifolds 1316 and heat sinks 1314 are installed. FIG. 13D shows the wound stator with the heat sink 1314 and coolant manifolds 1316 and 1318 installed. The winding produces the largest proportion of the motor's waste heat and this construction provides a very short thermal path for the winding heat to get to the heat sink. It should be understood that FIG. 13 is an example of a liquid cooled machine, other embodiments that employ cooling bars or heat pipes or plates are also considered.

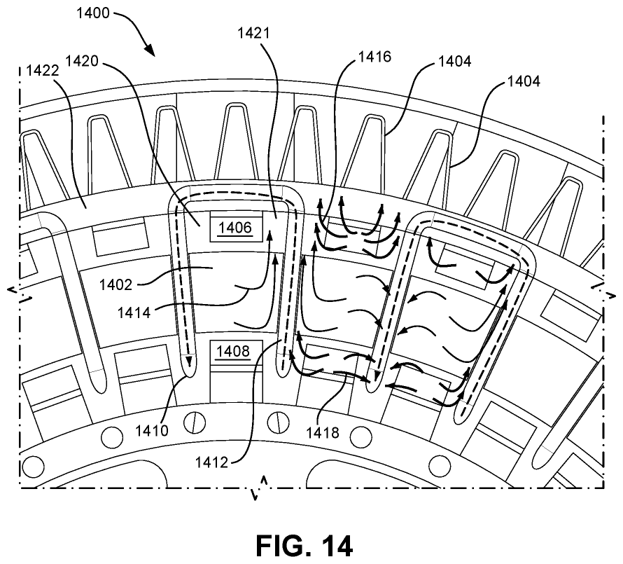

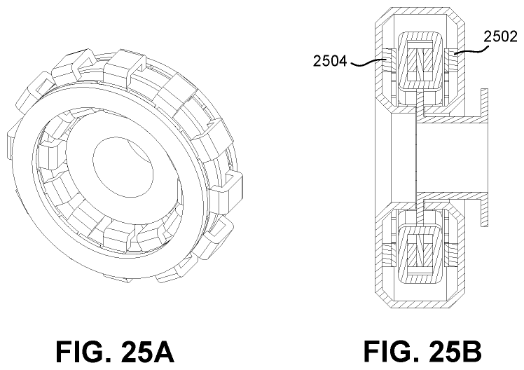

FIG. 14 shows a section view splitting the axial flux stator (e.g., in the axial flux machine corresponding to FIG. 13A-D) in half and showing a cross-section of a variant with liquid coolant channels. This diagram 1400 shows the coolant flow 1412 in dashed lines as it serpentines up in a coolant channel 1410 in one stator tooth 1420 and over open slot 1406 to the next tooth 1421. The open slots (e.g., 1406, 1408) of the stator includes the toroidal winding. The thin-lined arrows 1414 show how heat generated as core losses flows into the coolant 1412 as well as heat generated in the winding (shown as thick-lined arrows 1416 and 1418. FIG. 14 shows how short the path is from heat source (e.g., core 1402 and windings in slots 1406, 1408) to heat sink 1404. There are multiple ways to arrange the electromagnetics (radial flux, axial flux), as well as how to arrange the coolant channels and heat sinks for each type of machine. FIG. 14 shows the coolant channel 1410 flowing through the end-turn sandwich area 1420, then through the stator core 1402 to the other end-turn sandwich 1421 and then out to the outer housing 1422. Alternatively, the coolant channel could meander just inside the stator core, as shown in FIG. 25B, and not cross into the end-turn sandwich area. While FIG. 14 shows integrated heat sink fins 1404, if liquid cooling is used, the coolant can pass to a separate discrete heat sink/radiator. The channels could also just contain cooling bars with no liquid cooling.

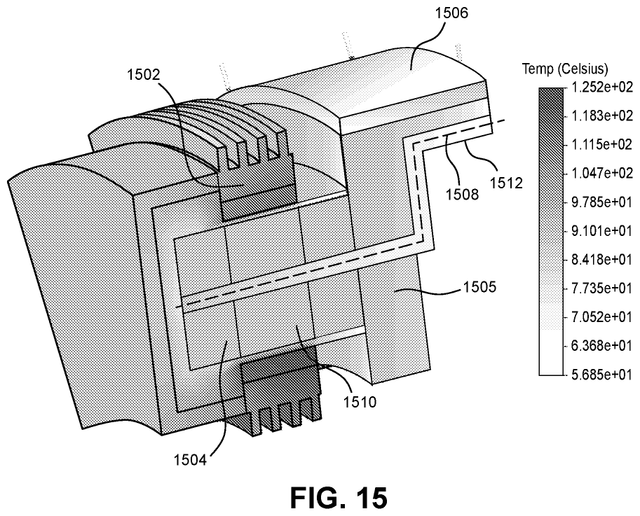

FIG. 15 shows a thermal Finite Element Analysis (FEA) simulation of a simplified model of the radial flux dual-airgap machine according to an embodiment, where a heat pipe 1508 is considered for transporting heat from the leftmost part of the end-turn sandwich area 1504, through the stator core 1510 then through the other side of the end-turn sandwich area 1505 and out to the heat sink 1506. It was observed that with an efficient heat sink, the sandwich construction significantly reduces winding temperatures. The grayscale from dark to light is indicative of the temperature distribution from high temperature to low temperature. The heat sink 1506 is shown in lighter shading indicating that it is cooler and the FEA shows that there is very little temperature rise from the heatsink to the winding, thus the winding stays cool.

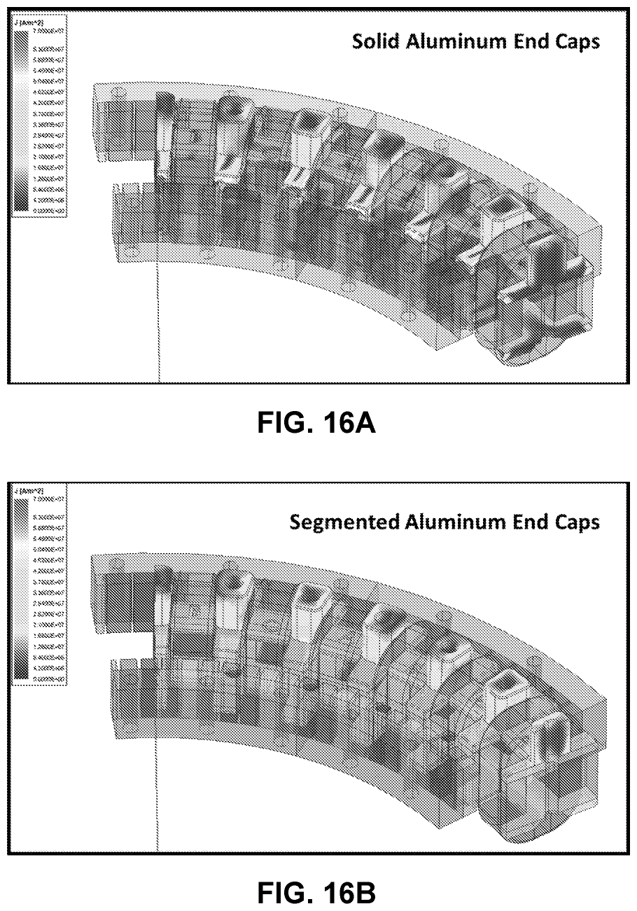

One key challenge is to select the best materials for the end-turn sandwich piece. The sandwich material needs to be highly thermally conductive, however it is right next to a winding carrying large time-varying currents. Thus, any electrically conductive material in close proximity, or passing through the coil, will have eddy currents induced in it. FIGS. 16A-16B show electromagnetic FEA simulation-based analysis of two different approaches to forming the sandwich construction. The sandwich construction represented in FIG. 16A used a solid aluminum piece with a segment that passes through the coil. The areas close to and under the coil have significant eddy currents induced in them-so much so as to cause more harm than good. The sandwich construction represented in FIG. 16B shows eddy currents induced in a segmented sandwich construction where an insulating material is used under the coil and solid aluminum to conduct heat down to the cooling channels.

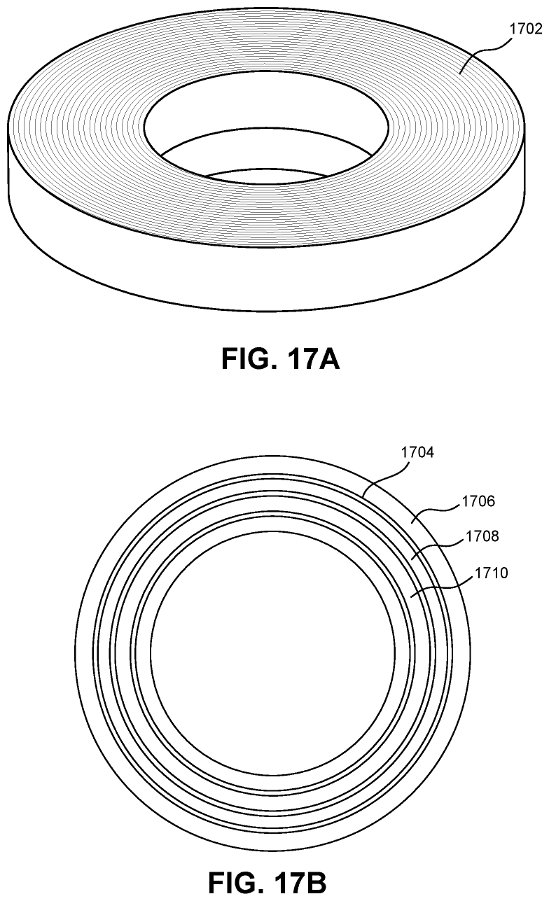

A preferable material for the end-turn sandwich is Aluminum Nitride (AIN) which is a non-electrically conductive ceramic that has a thermal conductivity close to that of aluminum. Another alternative is to use laminated thin aluminum strips/sheets bonded together (see FIG. 17A-17B) and machined to form the sandwich. This is the same reason that electric motor cores are made from laminations of thin electrical steel which are electrically insulated from each other. Anodized aluminum is one way of making an electrically insulating surface which can then be bonded to other anodized aluminum sheets, or, it can be wound up on a mandrel to form a cylinder or ring. The radial layers of laminations (e.g., 1706, 1708, 1710 which have electrical insulation between each layer) shown in FIG. 17B illustrate the construction of the wound anodized aluminum wound coil 1702 shown in FIG. 17A. The surface of the coil metal can be electrically insulated (e.g., thin insulating strips 1704) to block eddy currents.

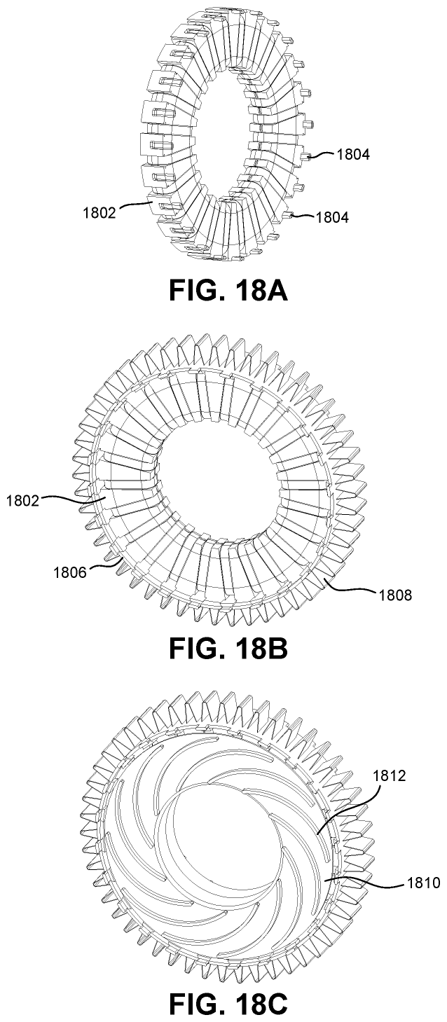

FIG. 18A-18C show an example of how the end-turn sandwich construction can be formed for an axial flux dual-airgap machine which utilizes bent rectangular heat pipes to carry heat out of the core, winding and end turns out to the stator housing and its integrated heatsink fins. FIG. 18A shows the cold-sandwich stator 1802 and heat pipes (e.g., 1804). FIG. 18B shows the stator 1802 installed in stator housing 1806 which includes a heatsink 1808. FIG. 18C shows the rotor housing 1810 having integrated centrifugal fan blades 1812 which drive cooling air out radially to cool the rotor. Ducts can be used to turn the air and drive it axially over the stator cooling fins 1808.

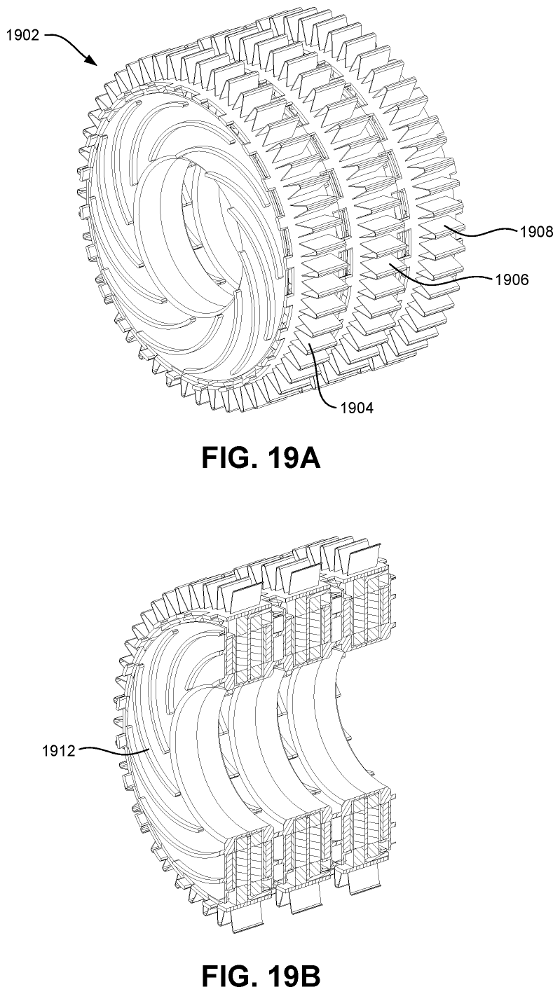

FIG. 19A and FIG. 19B show how axial flux machines can be axially stacked to form a larger motor. FIG. 19A shows three motors 1904, 1906 and 1908 stacked to form a larger motor (stacked motor/machine) 1902. This example, in the cross-section of machine 1902 as shown in FIG. 19B, shows how the rotor cooling blades (e.g., 1912) can pull air from the center of the machine over the inner segments of the motor to maintain uniform cooling for the stacked machine 1902.

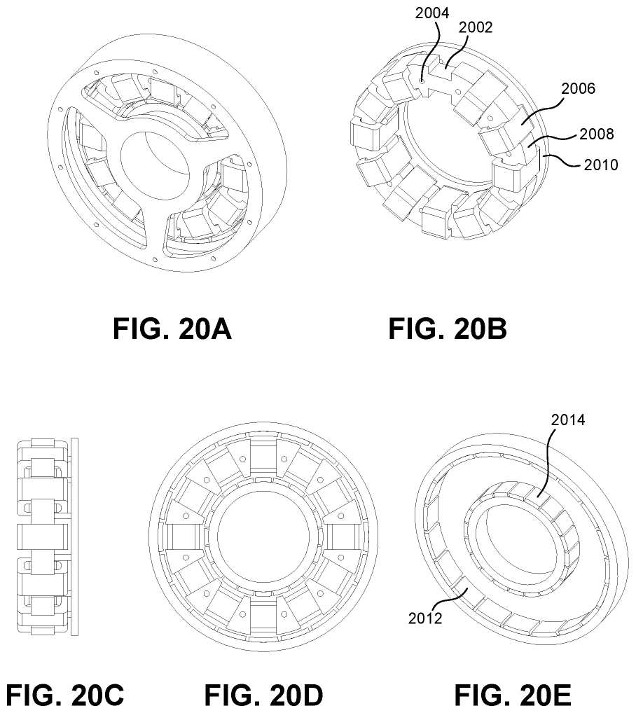

FIG. 20A-20E show aspects of a dual-airgap radial flux embodiment, such as, for example, the embodiment shown in FIG. 3A. FIG. 20A shows an example the assembled motor. FIG. 20B shows the stator with one of the plurality of coils that make up the winding 2006 being hidden to more clearly show the slot 2002. In the illustrated embodiment, the coolant channels 2004 may include metal tubes to mechanically connect the stator core 2008 to the outer frame/housing 2010. FIG. 20C illustrates a side view of the stator in FIG. 20B, and FIG. 20D shows a front view of the same and includes the rotor core and magnets. FIG. 20E shows the rotor with attached magnet arrays 2012 and 2014.

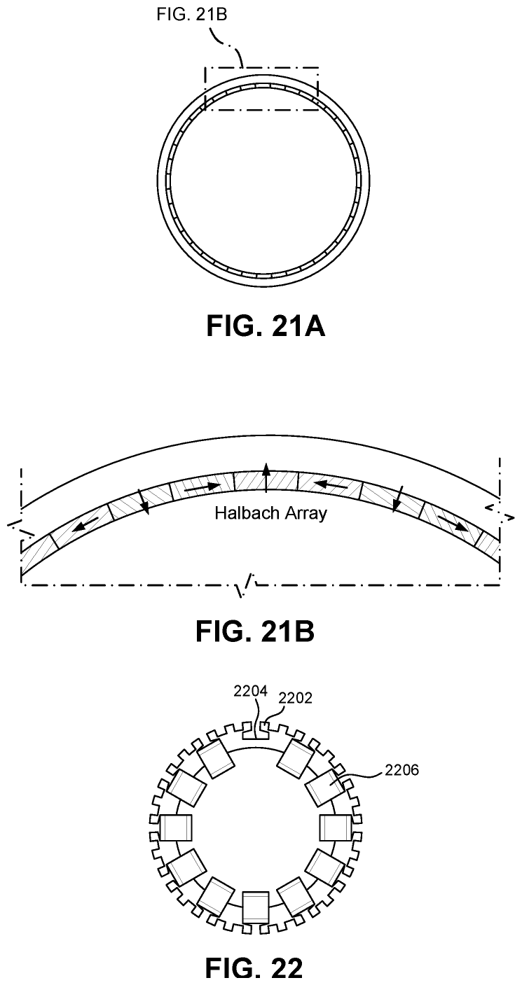

FIG. 21A illustrates a rotor with a Halbach array of magnets implemented thereon. The Halbach array is more clearly shown in FIG. 21B. It should be noted that whereas the illustrated Halbach array is constructed of 4-piece magnet segments in which each magnet is a 90-degree change in the flux direction, it is not limited thereto. For example, Halbach arrays of 8-piece magnets (e.g., 45-degree direction change between magnets) can be used among other approaches. In some embodiments, instead of the standard magnet array (i.e. non-Halbach) in the rotor shown in FIG. 20E, a Halbach array implementation of magnets in the rotor may be constructed as shown in FIG. 21A.

FIG. 22 illustrates a split tooth Vernier stator, in the form of a radial flux outrunner, in accordance with an embodiment. One of the plurality of coils 2206 is hidden to more clearly illustrate the semi-closed slot 2204 formed between a pair of “teeth with shoes” 2202. Split tooth Vernier machines embodiments have semi-closed slots whereas many of the embodiments shown in other figures feature open slot Vernier machines. The semi-closed slot can be wound with conventional manufacturing methods, but is more difficult to wind with a toroidal winding compared to an open slot. The stator teeth in the open slot construction and the split teeth nodules act as flux modulators which are necessary for the magnetic gearing effect in Vernier machines.

FIG. 23A and FIG. 23B show views of a five-airgap axial flux motor according to some embodiments. The rotor core/magnet assemblies 2302 and 2304 represent two axial flux directions, the rotor core/magnet assembly 2306 represents a radial flux direction, and the smaller rotor/magnet assemblies 2308 and 2310 represent an additional two radial flux directions, providing a five-airgap motor.

FIG. 24A and FIG. 24B show views of a three-airgap axial flux motor according to some embodiments. The rotor core/magnet assemblies 2402 and 2404 represent two axial flux directions, the rotor core/magnet assembly 2406 represents a radial flux direction, providing a three-airgap motor.

FIG. 25A and FIG. 25B show views of a two-airgap axial flux motor, according to some embodiments. The rotor core/magnet assemblies 2502 and 2504 represent two axial flux directions, providing a two-airgap motor.

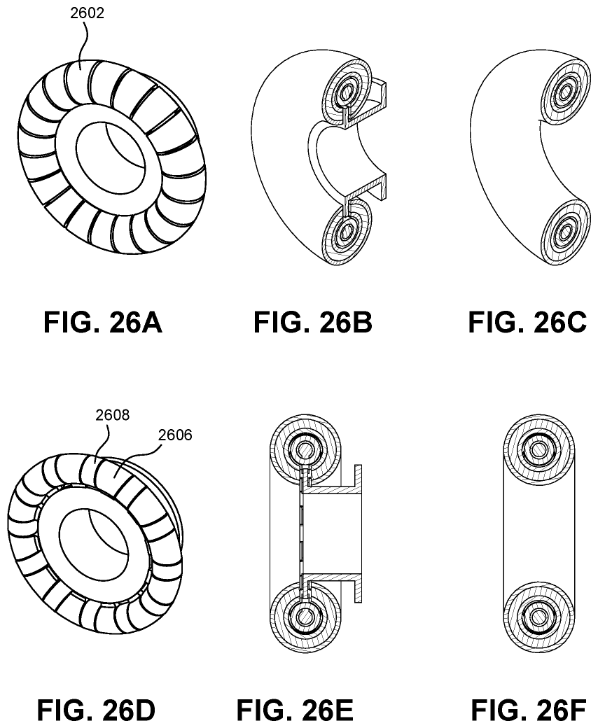

FIGS. 26A-26F show an embodiment in which the core and magnets are extended continuously on the rotor, instead of in segments (e.g., instead of segments such as 2402-2406). Mathematically, this can be expressed as the representation of a motor when N, the number of airgaps, goes to infinity, the spaces between them go to zero and become a continuum of an airgap. In FIG. 26A, the rotor magnets 2602 are visible and they hide the view of the stator. FIG. 26D hides the rotor magnets such that the coils 2608 and stator core 2606 are visible. FIGS. 26B, 26C, 26E and 26F show cross sections of the motor. It should be noted that if, for example, the representation in FIG. 26C was stretched out to form a cylinder, similar to a hydraulic cylinder, it would represent a linear actuator/motor.

### Manufacturing The Torque Dense Electric Motor

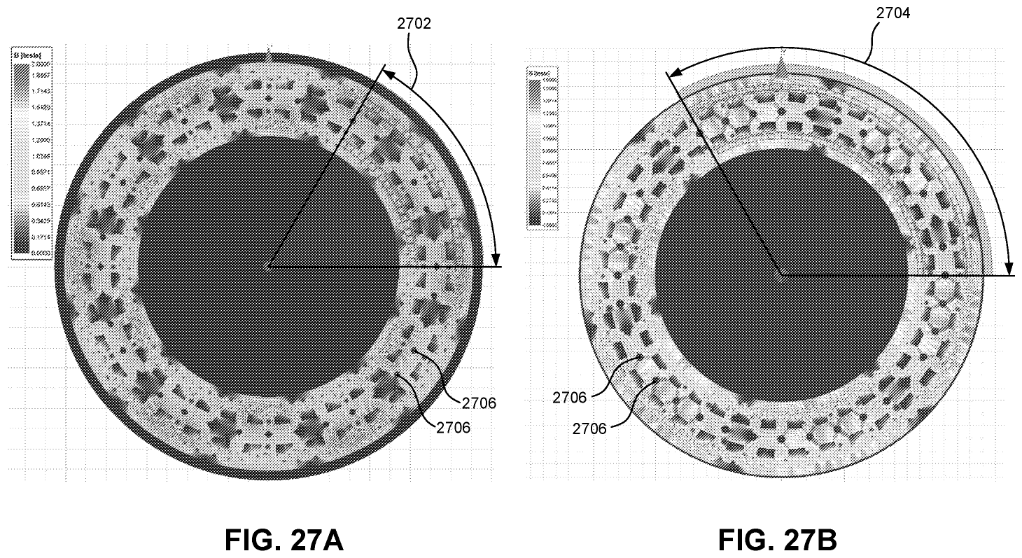

FIGS. 27A to FIG. 31B show aspects of the technology relating to unique manufacturing methods for fabricating a multi-airgap magnetically geared machine.

FIG. 27A and FIG. 27B show the flux lines from the FEA simulation of two Vernier motors with the same number of stator slots (e.g., as in FIG. 15) but different magnetic gearing ratios (pole ratios). The overlaid triangles 2702 and 2704 show the smallest atomic segment. The motor is an integer multiple of this unique segment (i.e. the flux pattern repeats). FIG. 27A shows a motor with a 5:1 pole ratio which is formed from 12 repeating segments. FIG. 27B shows a motor with an 11:1 gear ratio which is formed from 6 repeating segments. When manufacturing the stator one can manufacture segments, which can be any integer multiple of the atomic segment, and then assemble them into the final stator. While it would likely be uneconomical to manufacture 12 segments, both of these machines can be segmented in other manners, e.g., half or thirds. Having an open segment makes winding the stator segments easier and lowers winding costs since the topology of the toroidal winding changes to a simpler one. However, the segments then must be assembled which adds some assembly cost and reduces magnetic performance.

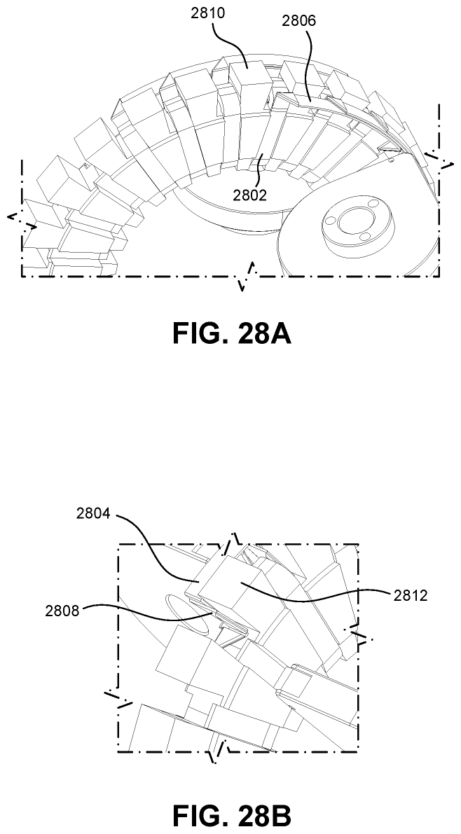

FIG. 28A-28B illustrate a method to deterministically and compactly wind a multi-airgap Vernier machine when using flat, wide ribbon of conductors (e.g., ribbons 2802, 2804) with careful cutouts (e.g., shown in 2806, 2808) in the end-turn sandwich (e.g., 2810, 2812). FIG. 28A illustrates a folded ribbon winding exit (from the winding) and FIG. 28B shows a folded ribbon winding entry (into the winding). Careful design of the folds and cavities enables maximum area contact of the winding to the sandwich while minimizing extra end-turn volume.

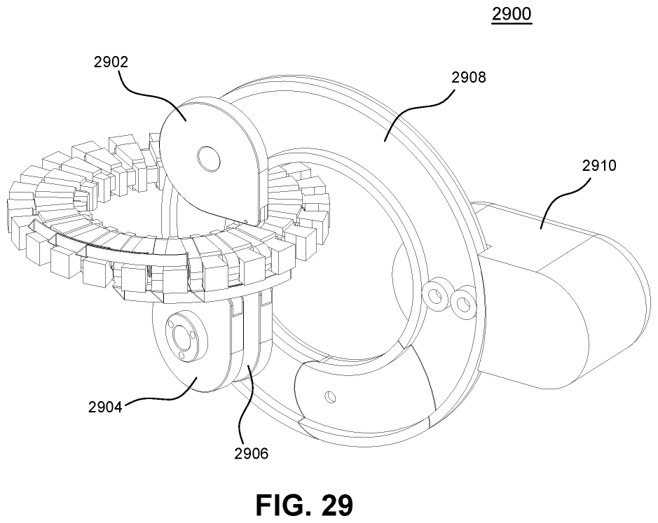

FIG. 29 shows an example of a toroidal winding machine 2900 capable of winding multi-airgap Vernier machines of some embodiments. A challenge with this technology is that in order to form a toroidal winding one has to spool up the winding wire/ribbon on sub-spools that are small enough to pass through the interior of the core. For the most compact winding, all phases must be wound sequentially, winding all adjacent slots for one phase, then switching to the next phase and winding all adjacent slots for that phase, switching again until the first group of slots for all phases has been wound, then the first phase passes over or around the slots that were just wound and the process repeats. FIG. 28A shows the winding exiting a slot and the end-turn 2806 crossing over two slots occupied by other phases and then re-entering another slot. This matches the winding pattern of the 36-slot, 60-pole, 5:1 pole-ratio motor shown on the left of FIG. 27A and detailed in FIG. 5A. Because the slot-to-slot wire must cross over other slots, the winding process must proceed slot by slot alternating phases to make the most compact and balanced winding, however other methods are possible. FIG. 29 shows a three-phase winding and thus three sub-spools (sub-spool phase A 2902, sub-spool phase B 2904, and sub-spool phase C 2906) are used to wind. The method involves an actuated ring 2908 that grabs one sub-spool and spins, forming the toroidally wound coil in that slot. The actuated ring can be opened to un-interlock the two toroids. The actuator 2908, or another robotic arm (e.g., positioner 2910), for example, can then move the sub-spool to a parking position and then grab the next sub-spool. The positioner 2910 could be a generic robotic arm, or a more dedicated actuator made specifically for this winding operation. If the stator core is a segment rather than a full toroidal core, the winding process can utilize the positioner alone to manage the spool change and parking/unparking maneuvers.

The inter-slot winding shown in FIG. 28A and FIG. 28B show the ribbon crossing over the top of the slot. It is possible to run the inter-slot ribbon under the winding end-turns. The end-turn length has to be made larger to accommodate this, which may not be worth it for wide ribbons, but it is possible. When using multiple ribbons, this end-turn extra length can be somewhat reduced. Furthermore, it is possible to wind each phase separately if the inter-slot ribbon goes under the end-turn of the subsequent slot. There are some challenges in making sure that the windings have the exact same length and are balanced because each phase will have a different inter-slot pattern. However, this eliminates the need for the parking sub-spools after each slot is completed.

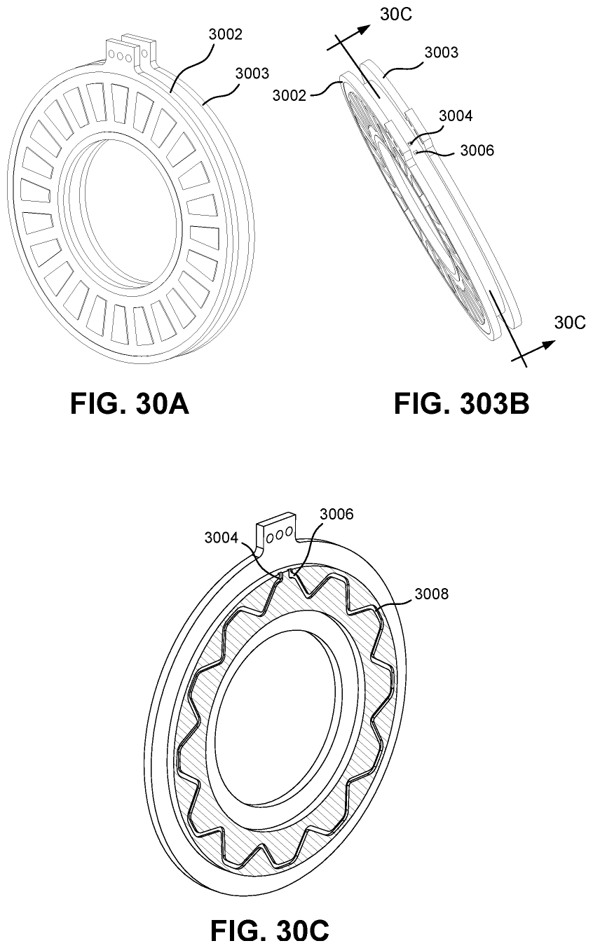

An alternative to the toroidal winding approach shown in FIG. 30 is to form the coils and end turns of a winding with the Printed Circuit Board (PCB) process. While the PCB process is limiting in the packing factor that can be achieved compared to the wide ribbon process shown in FIG. 6, it could be well suited to smaller motors for which it is more difficult to make sub-spools (such as that would be required if machine 2900 were to be used) small enough to fit through the inside diameter of the stator core. FIG. 30A shows how the flat PCB stator winding 3002, 3003 can be integrated into a dual-airgap axial flux Vernier machine. Note that there are two winding PCBs for each air gap. The PCB stator will work equally well for a single air-gap axial flux machine, Vernier or standard. FIGS. 30B and 30C show coolant ports 3004 and 3006 and the corresponding coolant channel 3008. A challenge for the Vernier motors is that the electromagnetic gearing requires open slots, the winding thus needs finely, insulated strands of wire to form the winding to minimize eddy current losses in the conductors. The etching limitations of the PCB process limits how narrow the gap can be between conductors. Thus, the PCB winding process will have lower packing factor and may be either less efficient or heavier than the ribbon winding method. However, for lower speed applications eddy current losses are not as significant and this becomes less of a problem.

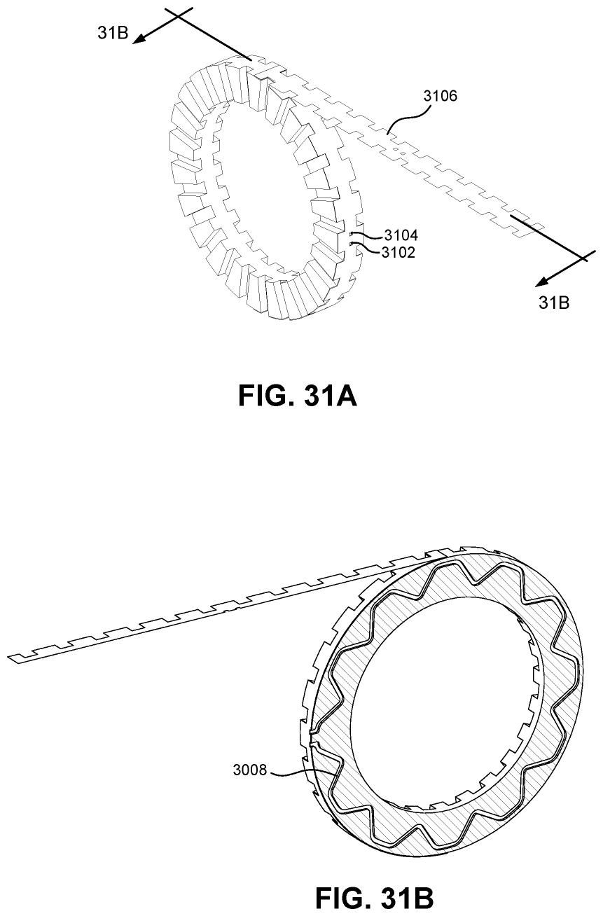

FIG. 31A and 31B show the winding of a tape of thin core material (e.g., electrical steel) on a mandrel to form the toroidal core. The most basic version winds a simple flat tape to form the cylindrical core (toroid with rectangular cross-section). The concentric laminations of the core can be joined into a rigid core in similar ways to conventional stacked laminations which can adhesively bond the layers, use interlocking snap features or welding. If the core is sufficiently solid, features can be machined into it. However, FIG. 31A shows that features (e.g., 3102, 3104), both exterior and interior, can be cut into the tape (e.g., 3106) before or during winding and then wound onto the fully featured core. This is the wound equivalent of the common stacking method used for radial flux machines where the slot features and cooling cavities are laser cut, etched or stamped into the individual laminations prior to assembly of the stack. The method shown can have the features cut via laser cutter, stamp or photolithographically etched. The spacing between slot and cavity features has to be carefully controlled and continuously varied throughout the process because the features will tend to get further apart as the radius of the wind increases.

FIG. 31B shows how completely internal channels, such as channel 3008 shown in FIG. 30C, can be formed with this process enabling things like serpentine coolant paths that pass through the entire core but have only two small ports for example (e.g., ports 3004, 3006 shown in FIG. 30B). Interlocking snaps can be punched in as precision clocking features to maintain correct feature registration during the winding process. The snaps can also hold the laminated layers in precise registration until a later resin infusion step for example. This manufacturing method can be used with any thin strip or sheet material such as aluminum or carbon fiber. This method can be used to form the aluminum end-turn sandwich for a radial flux machine with cutouts for the end-turns as an example.

In example embodiment, the problem of efficient electric motors that are too voluminous and too heavy is solved by a multi-airgap magnetically geared machine with a compact toroidal winding which utilizes a thermally conductive and structural spine/sandwich component to mechanically hold the stator and conduct away waste heat.

In motors, pᵣ=p_{FM}±pₛ, where: pᵣ—number of rotor pole pairs, pₛ—number of stator pole pairs, and p_{FM}—number of flux modulators. The pole ratio is defined as pᵣ/pₛ. Whereas in non-magnetically geared motors (most standard motors) have a pole ratio of 1, magnetically geared motors have a pole ratio greater than 1.

In embodiments, the multi-airgap magnetically geared machine includes a Vernier motor. In the open slot construction of example embodiments, the number of flux modulators is the same as the number of stator slots/teeth.

The stator core of the motor in embodiments can be formed from electrically insulating layers/laminations or particles. Thin electrical steel laminations are used to minimize stator core losses. For laminations, the lamination direction is the cross product of the air gap surface and motion direction (i.e., normal to both). The stator has a yoke (an annulus) and teeth made of ferrous material (e.g. relative permeability much greater than 1). In some embodiments a thermally conductive frame holds onto the back of the stator providing mechanical structure and conducting heat away from stator.

The rotor of the motor in example embodiments may be constructed with solid steel for cost savings or can be made from insulating laminations or particles. Thin electrical steel laminations may be used to minimize rotor core. In some embodiments, the rotor may be a surface permanent magnet (SPM) rotor, which has magnets bonded to the rotor ring structure (e.g., to the rotor yoke). The rotor has a yoke (an annulus) of ferrous material. In some embodiments, the rotor may have magnets buried inside the core (e.g., interior permanent magnets (IPM)). Rotor magnets may be “skewed” to reduce torque ripple. Rotor magnets may be segmented tangentially and axially, with electrically insulating layers between them, to reduce eddy current losses. A thermally conductive frame holds onto the back of the rotor providing mechanical structure and conducting heat away from rotor.

In some embodiments, using Halbach magnetization for magnets in the rotor provides the multi-airgap magnetically geared machine with a very small size and a very small weight. Using surface permanent magnets in a Halbach array was found to provide the most torque with the least weight among several options for rotor magnetization in embodiments.

However, embodiments are not limited to using Halbach magnetization in the rotor(s). The magnetic gearing in embodiments can work with many other types of rotor magnetization including, for example, standard magnet array (e.g., alternating north, south magnets), consequent pole (e.g., little steel teeth around the magnets), and interior permanent magnet (IPM). Alternatively, in some embodiments, the rotor(s) may have no magnets at all in accordance with a synchronous reluctance motor (SRM) design.

Windings are formed of connected coils, coils are made of wound strands of wire, or “formed” rectangular copper bars. Concentrated windings have the smallest “end-turns” which saves weight. Formed windings have the highest “fill-factor” which minimizes ohmic losses.

Embodiments use toroidal windings. The technology of the embodiments provides a stator core formed of a torus with teeth (and therefore slots). The winding wire fits within the slots as opposed to being evenly distributed around the torus such as is the case for a toroidal transformer. Stranded wire bundles or ribbons may be used to mitigate skin effect losses. Wire strand position may be controlled to mitigate proximity effect losses (e.g., Litz wire controls position within slot, ribbon and ribbon sub-segments twisted between slots). In some embodiments, the winding can be segmented for redundancy. The winding can be segmented to provide different series/parallel combinations for induced voltage/impedance control. Winding and/or end-turns can be formed from PCBs for axial flux and radial flux machines respectively. In some embodiments, combinations of etched copper foil laminates can be stacked or wound to form flat or round windings or circuits.

Embodiments arrange the stators and rotors in a multi-airgap topology by arranging multiple (e.g., 2-5) motor sections “back-to-back” (e.g., substantially more than 50% of the perimeter of the stator cross section has flux crossing an airgap). The slots associated with each airgap can be rotated or shifted relative to each other (i.e., clocked) to trade off magnetic efficiency with winding size. The clocking can be used to cancel out or minimize torque ripple produced in each airgap. The thermally conductive and structurally strong frame is placed in the “center” of the cores to both mechanically support them and carry heat away. The frame may be hollow and carry cooling fluids. In some embodiments, the stator slots may be “skewed” to reduce torque ripple.

The term “skew” may be used to represent a twist about the axis of rotation of the features of any of the stator core, rotor core, or magnets. Such a twist may be constructed to control torque ripple.

The term “clocking” may be used to represent the relative angle between two components that share the same axis of rotation. This may also be referred to as alignment or registration. While clocking generally refers to a continuous angular alignment, the term “indexing” may be used to indicate a discrete integer number of angular options.

The magnetic materials (core and magnets) in embodiments can be constructed in any of several ways. For example, they may be constructed from laminated sheets by using thin laminates or segments with an electrically insulating layer between laminates. In another example, they may be constructed from particles by using particles with electrically insulating film/layer between particles. The particles can be sintered into a solid (e.g., ferrites), or can be bonded with an epoxy matrix (e.g., bonded magnets).

Eddy currents are another motor construction challenge. Motors are constructed of ferromagnetic cores, windings made of copper, and some motors include permanent magnets, all of which are electrically conductive. Eddy currents are induced in conductive materials when exposed to time varying magnetic fields and can be a significant source of power loss or wasted energy in a motor. To mitigate these sources of losses, embodiments may be configured to block eddy currents from flowing in each component.

In some embodiments, as a general description, an approach of mitigating eddy currents in a conductive component is to split up the component into several smaller components with an electrically insulating layer between them.

For example, for ferromagnetic cores (e.g., stator and rotor) one method of mitigating eddy currents in embodiments is to use a stack of thin laminations of “electrical steel” where each lamination has a thin electrically insulating coating to prevent current from flowing in the stack direction (from lam to lam). Electrical steels are alloys of iron that have high magnetic permeability and higher electrical resistance. Another method is sintered powdered metal, where the ferromagnetic particles have an electrically insulating film. This results in the lowest losses and magnetic flux can go in both axial and radial directions.

A winding is composed of a set of coils connected in appropriate series and parallel connections. Coils are formed from 1 or many strands of “magnet wire” where each wire has a thin electrically resistive coating to confine electric currents to only flow along the length direction of the wire. The strands are also often chosen to mitigate the “skin effect” and results in the lowest AC electrical resistance (thus minimizes ohmic losses). Some embodiments further improve the winding resistance by using rectangular or square magnet wire and carefully controlling the placement of each strand. This maximizes the “packing factor” (fill factor), which is the ratio of copper cross-section to available cross-section in the coil “slot”. In some embodiments, wire strands can be twisted in a particular manner, often referred to as “Litz” wire (e.g., Litz wire in a type 7/8 construction or ribbon) to mitigate what is called the “proximity effect” where different strands in the same bundle (or electrical node) have different induced voltages because of their relative location in the slot. The Litz twisting, or other controlled strand placement method, can be used to ensure that each strand spends roughly the same amount of its length in all potential slot locations, thus evening out this strand-to-strand voltage difference.

With regard to permanent magnets (PMs), in example embodiments, the PMs can be split up in both the tangential and axial/stack directions with electrical insulation between magnet segments (could be an insulating material or just space) to mitigate eddy currents. This is referred to as “segmenting the magnets”.

The problem of efficient electric motors that are too voluminous and too heavy is solved in embodiment of this disclosure by maximizing flux linkage using a substantially small stator mass and rotor mass. In example embodiments, the task of delivering electromagnetic torque to a moving/rotating output is addressed by producing a moving (e.g., time varying) magnetic field with an electromagnet which interacts with fields made by permanent magnets. The task of maximizing flux linkage and therefore torque is addressed by using magnetic gearing. Vernier is a type of magnetic gearing machine used in example embodiments.

Vernier magnetic gearing requires coil spans larger than 1, open slot

construction of stator, enables time-varying flux to cross through permanent magnets, and causes the ferromagnetic (e.g., silicon, cobalt steel, or other) rotor core to carry vernier flux. These aspects of Vernier, however, introduce challenges: large coil spans lead to large end-turn mass with standard winding approach; open slot configuration causes side-effects due to proximity effect (e.g., non-uniform voltage and current distribution across the slot); time-varying flux crossing the permanent magnets cause magnet eddy current losses; and Vernier flux being carried by the rotor core causes rotor core losses.

In embodiments, the challenge of large end-turn winding mass is addressed by placing two or more stators back-to-back and clocking them relative to each other and forming toroidal coils (Gramme winding) to form a compact winding with minimal end-turn copper. In some embodiments, the challenge of proximity effect losses is addressed by using ribbon of stranded wires and controlling the twist between stator slots and/or techniques such as Litz wire braids/ribbons. In some embodiments the challenges of reacting torque and removing heat from the stator is addressed with structural and thermally conductive spine placed in between the stators and connecting out to the frame. In some embodiments, the challenge of Ohmic losses (e.g., heat) in the winding is addressed by forming the ribbon out of rectangular/square wire to minimize winding resistance in the finite slot area. In some embodiments, the challenge of minimizing rotor mass is addressed by using a permanent magnet Halbach array which makes more flux for the same mass and reduces rotor core thickness. In some embodiments, the challenge of rotor heat is addressed by conducting the heat produced in the magnets and cores out to a rotor frame which conducts the heat away, and the frame may also deliver the electromagnetic torque to the load output. In some embodiments, the challenge of magnet eddy current losses is solved by segmenting the magnets with thin electrically insulating barriers.

Embodiments of this technology enables the option of eliminating a gearbox in many applications. Eliminating or minimizing the gearbox helps reduce weight and eliminate or reduce lubrication systems such as pumps, filters, piping, etc.

The embodiments discussed thus far has referred to the invention as a motor. However, the motors can also be used as a generator or alternator. When mechanical shaft power is used to spin the rotor, a voltage is induced in the winding which will supply electrical power to a load. Thus the motor is equally well suited to generator applications as motor applications.

In an aspect, this disclosure provides a magnetically geared apparatus configured either as an electric motor or as a generator. The apparatus comprises a stator structure and a rotor structure arranged to improve torque generation. The stator structure contains N≥1 stator cores and a shared toroidal electrical winding, and the rotor structure contains an equal number of corresponding rotor cores.

The apparatus of described in the paragraph immediately above, wherein the apparatus is a Vernier machine. The N stator cores of the Vernier machine are arranged back-to-back. The N stator cores may be integrated into a single physical core.

The apparatus described in any one or more of the two paragraphs immediately above, wherein a respective cold sheet (e.g., a “cold plate” (i.e. a planar cooling structure) for an axial flux machine or a “cold cylinder” for a radial flux machine) and one or more cooling channels are arranged between each pair of stator cores. The respective cold sheets may incorporate the one or more cooling channels.

The apparatus described in the any one or more of the three paragraphs immediately above may include any one or a combination of: one or more thermal channels configured to transport heat out of the stator structure; a housing structure and a plurality of mechanical supports configured to connect the N stator cores to the housing structure; a plurality of magnets arranged in a Halbach configuration and attached to a least one rotor core; the N stator cores and/or the N rotor cores being configured to reduce eddy currents; electrically insulated ferromagnetic laminations arranged with a lamination direction orthogonal to an airgap surface and orthogonal to the direction of motion of the rotor relative to the stator thereby limiting eddy currents within the stator and rotor cores; the N rotor cores and/or the N stator cores being formed of ferromagnetic particles that are electrically insulated from each other thereby limiting eddy currents within the rotor and/or stator cores; the N stator cores comprising stator core teeth arranged in a substantially open-slot configuration for flux modulation.

The apparatus described in the any one or more of the four paragraphs immediately above may have the N stator cores substantially fused within the stator structure and/or the N rotor cores may be substantially fused within said rotor structure such that the toroidal winding is substantially encompassed by the substantially fused stator and/or substantially fused rotor.

The apparatus described in the any one or more of the five paragraphs immediately above comprising a housing structure and a plurality of mechanical supports configured to connect the N stator cores to the housing structure. The plurality of mechanical supports may be further configured to transport heat out of the stator structure.

The toroidal winding in the apparatus described in the any one or more of the six paragraphs immediately above may comprise flat ribbons made of multiple strands of electrical wire and placed within stator core slots. The ribbons may be made of a Litz wire construction, or strand of electrical wire may have a rectangular cross-section thereby minimizing Ohmic losses. The position of each said strand of electrical wire within the ribbon may be varied for respective stator core slots so as to minimize the proximity effect thereby minimizing Ohmic losses.

The apparatus described in the any one or more of the seven paragraphs immediately above may have the stator structure and the rotor structure arranged to maximize axial flux and/or radial flux.

The apparatus described in the paragraph immediately above, wherein (1) N=2, and wherein the N stator cores and the N rotor cores are arranged to form a dual-airgap radial flux machine; (2) N=2, and wherein the N stator cores and the N rotor cores are arranged to form a dual-airgap axial flux machine; (3) N=3, and wherein the N stator cores and the N rotor cores are arranged to form a three-airgap flux machine comprising either two axial airgaps and one radial airgap or one axial airgap and two radial airgaps; (4) N=4, and wherein the N stator cores and the N rotor cores are arranged to form a five-airgap flux machine comprising either two axial airgaps and three radial airgaps or three axial airgap and two radial airgaps; or (5) the N stator cores and the N rotor cores are arranged to form a multi-airgap machine wherein the airgaps are contiguous, wherein the multi-airgap flux machine may be configured as a linear machine.

All patents, patent applications and publications cited herein are incorporated by reference for all purposes as if expressly set forth.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A magnetically geared apparatus configured either as an electric motor or as a generator, and comprising a stator structure and a rotor structure arranged to improve torque generation wherein:
said stator structure contains N≥1 stator cores and a shared toroidal electrical winding; and
said rotor structure contains an equal number of corresponding rotor cores.

2. The magnetically geared apparatus of claim 1, wherein said apparatus is a Vernier machine.

3. The magnetically geared apparatus of claim 2, wherein the N stator cores are arranged back-to-back.

4. The magnetically geared apparatus of claim 3, wherein a respective cold sheet and one or more cooling channels are arranged between each pair of back-to-back stator cores.

5. The magnetically geared apparatus of claim 4, wherein the respective cold sheet incorporates the one or more cooling channels.

6. The magnetically geared apparatus of claim 3, wherein the N stator cores are integrated into a single core.

7. The magnetically geared apparatus of claim 1, further comprising one or more thermal channels configured to transport heat out of the stator structure.

8. The magnetically geared apparatus of claim 1, further comprising a housing structure and a plurality of mechanical supports configured to connect the N stator cores to the housing structure.

9. The magnetically geared apparatus of claim 8, wherein said plurality of mechanical supports are further configured to transport heat out of the stator structure.

10. The magnetically geared apparatus of claim 1, further comprising a plurality of magnets arranged in a Halbach configuration and attached to a least one rotor core.

11. The magnetically geared apparatus of claim 1, wherein the N stator cores and/or the N rotor cores are configured to reduce eddy currents.

12. The magnetically geared apparatus of claim 1, wherein electrically insulated ferromagnetic laminations are arranged with a lamination direction orthogonal to an airgap surface and orthogonal to the direction of motion of the rotor relative to the stator thereby limiting eddy currents within the stator and rotor cores.

13. The magnetically geared apparatus of claim 1, wherein the N rotor cores and/or the N stator cores are formed of ferromagnetic particles that are electrically insulated from each other thereby limiting eddy currents within the rotor and/or stator cores.

14. The magnetically geared machine of claim 1, wherein the N stator cores comprises stator core teeth arranged in a substantially open-slot configuration for flux modulation.

15. The magnetically geared apparatus of claim 1, wherein the N stator cores comprise split-teeth flux modulators.

16. The magnetically geared apparatus of claim 1, wherein said N stator cores are substantially fused within said stator structure and/or said N rotor cores are substantially fused within said rotor structure such that the toroidal winding is substantially encompassed by the substantially fused stator and/or substantially fused rotor.

17. The magnetically geared apparatus of claim 1 wherein said toroidal winding comprises flat ribbons made of multiple strands of electrical wire and placed within stator core slots.

18. The magnetically geared apparatus of claim 17 wherein said ribbons are made of a Litz wire construction.

19. The magnetically geared apparatus of claim 17 wherein each said strand of electrical wire has a rectangular cross-section thereby minimizing Ohmic losses.

20. The magnetically geared apparatus of claim 17 wherein a position of each said strand of electrical wire within said ribbon is varied for respective stator core slots so as to minimize the proximity effect thereby minimizing Ohmic losses.

21. The magnetically geared apparatus of claim 1 wherein said stator structure and said rotor structure are arranged to maximize axial flux and/or radial flux.

22. The magnetically geared apparatus of claim 1, wherein N=2, and wherein the N stator cores and the N rotor cores are arranged to form a dual-airgap radial flux machine.

23. The magnetically geared apparatus of claim 22, wherein 3 out of 4 sides of the toroidal winding is cooled.

24. The magnetically geared apparatus of claim 1, wherein N=2, and wherein the N stator cores and the N rotor cores are arranged to form a dual-airgap axial flux machine.

25. The magnetically geared apparatus of claim 1, wherein N=3, and wherein the N stator cores and the N rotor cores are arranged to form a three-airgap flux machine comprising either two axial airgaps and one radial airgap or one axial airgap and two radial airgaps.

26. The magnetically geared apparatus of claim 1, wherein N=4, and wherein the N stator cores and the N rotor cores are arranged to form a five-airgap flux machine comprising either two axial airgaps and three radial airgaps or three axial airgap and two radial airgaps.

27. The magnetically geared apparatus of claim 1, wherein the N stator cores and the N rotor cores are arranged to form a multi-airgap machine wherein the airgaps are contiguous.

28. The magnetically geared apparatus of claim 27, wherein the multi-airgap flux machine is configured as a linear machine.

29. The magnetically geared apparatus of claim 17, wherein the multiple airgaps merge into a single combined airgap.

29. The magnetically geared apparatus of claim 1, wherein the toroidal winding is a printed circuit board (PCB) winding.

30. A magnetically geared dual-airgap apparatus configured either as an electric motor or as a generator, and comprising a stator structure and a rotor structure arranged to improve torque generation wherein:
said stator structure contains 2 stator cores and a shared toroidal electrical winding; and
said rotor structure contains 2 corresponding rotor cores, wherein the stator cores and the rotor cores are arranged to form a dual-airgap radial flux machine or a dual-airgap axial flux machine.

31. A magnetically geared three-airgap apparatus configured either as an electric motor or as a generator, and comprising a stator structure and a rotor structure arranged to improve torque generation wherein:
said stator structure contains 3 stator cores and a shared toroidal electrical winding; and
said rotor structure contains 3 corresponding rotor cores, wherein the stator cores and the rotor cores are arranged to form a three-airgap flux machine comprising either two axial airgaps and one radial airgap or one axial airgap and two radial airgaps.
